(19) United States
(12) Patent Application Publication
(10) Pub. No.: US 2026/0051723 A1
(43) Pub. Date: Feb. 19, 2026

(54) INTERCONNECTABLE CONDUIT COMPONENTS

(71) Applicant: Yolda Works, LLC, Gillette, WY (US)

(72) Inventors: Tracy Harmer, Gillette, WY (US); Terry Harmer, Gillette, WY (US)

(73) Assignee: Yolda Works, LLC, Gillette, WY (US)

(21) Appl. No.: 18/805,461

(22) Filed: Aug. 14, 2024

(51) Int. Cl. H02G 3/04; H02G 3/00

(52) U.S. Cl. CPC H02G 3/0475; H02G 3/263

(57) ABSTRACT

Certain aspects of the disclosure provide a modular conduit assembly, comprising: a plurality of straight conduit segments; one or more corner conduit segments, each comprising a bend of a predetermined angle; and a plurality of joint connectors configured to interconnect the straight conduit segments and the one or more corner conduit segments to form an enclosed pathway for routing one or more cables or wires.

### BACKGROUND

### Field

Aspects of the present disclosure relate to cable and wire installation in buildings and structures. More specifically, aspects of the present disclosure pertains to systems, methods, and apparatuses for efficiently installing and managing various types of cabling and wiring infrastructure, including telecommunications, power, low voltage, and control cabling.

### Description of Related Art

In modern buildings and structures, the installation of cabling and wiring is an important aspect of construction and renovation projects. This includes telecommunications cabling, such as copper and fiber optic cables, as well as power, low voltage, and control wiring. These cables and wires provide the necessary infrastructure for a wide range of systems, including voice and data communication, electrical power distribution, lighting control, security, and building automation. Traditionally, the installation of cables and wires has been a labor-intensive and time-consuming process, requiring skilled electricians to manually pull individual cables and wires through conduits and cable trays.

Conventional cable and wire installation methods typically involve the use of bulk cable spools or reels, from which individual cables and wires are pulled and routed to their designated endpoints. Electricians must carefully measure and cut each cable or wire to the required length, ensuring sufficient slack for termination and future maintenance. Once the cables and wires are pulled through the conduits or laid in cable trays, they must be terminated at both ends using specialized tools and techniques. This process is repeated for each individual cable or wire and/or bundle of cables or wires, resulting in a significant amount of on-site labor and potential for errors.

The traditional approach to cable and wire installation poses several challenges and limitations. First, the process is highly dependent on the skill and experience of the electricians performing the work. Inconsistencies in cable and wire routing, termination, and labeling can lead to system performance issues and difficulties in future maintenance. Second, the manual nature of the installation process is time-consuming and labor-intensive, leading to longer project timelines and increased labor costs. Third, the on-site handling and termination of cables and wires introduce opportunities for damage, contamination, and human error, which can negatively impact system reliability and performance.

Moreover, the conventional method of pulling individual cables and wires through conduits and cable trays presents several logistical challenges. The process requires careful coordination among electricians to ensure that the correct cables and wires are pulled to their designated locations and that the cable paths do not become congested or blocked. The use of bulk cable spools and reels also necessitates a significant amount of on-site storage space and material handling, which can be problematic in space-constrained construction sites. Additionally, the manual pulling of cables and wires can be physically demanding and poses ergonomic risks to the electricians involved, which may reduce an already limited pool of labor for performing such work. In some cases, using a bulk cable spools and reels may be wasteful in that extra wire may be left on the spool that cannot be used. Further, in some instances, some improperly sized wire may place additional load on the building structure and/or strain on one or more components. In some aspects, utilizing bulk cable spools and/or reels may be the source of worker safety issues, including pulled and strained muscles.

Another drawback of traditional cable and wire installation is the limited ability to test and verify the performance of the installed cables and wires. While basic continuity testing can be performed on individual cables and wires, comprehensive testing of the entire system often requires specialized equipment and expertise. Any issues or defects discovered during testing may necessitate rework or replacement of the affected cables or wires, leading to further delays and increased costs.

In recent years, there has been a growing demand for more efficient and streamlined methods of installing cables and wires in buildings and structures. Building owners, contractors, and end-users are seeking solutions that can reduce installation time, minimize labor costs, improve system reliability, and facilitate future maintenance and upgrades. This has led to the development of various innovations and technologies aimed at addressing the limitations of traditional cable and wire installation methods.

One area of focus has been the development of cable and wire management systems and accessories which have mostly remained unchanged for years. These include cable trays, conduit systems, and cable support products designed to simplify cable and wire routing, reduce cable stress, and improve organization. While these solutions can help alleviate some of the challenges associated with traditional cable and wire installation, they do not fundamentally change the manual and labor-intensive nature of the process.

Despite the efforts to improve cable and wire installation methods, there remains a need for a comprehensive solution that addresses the key challenges and limitations of traditional approaches. Such a solution should aim to reduce on-site labor, minimize the potential for errors and inconsistencies, improve system reliability and performance, and provide a more efficient and cost-effective means of installing and managing various types of cabling and wiring infrastructure in buildings and structures and improving safety onsite.

### SUMMARY

Certain aspects provide a modular conduit assembly, comprising: a plurality of straight conduit segments; one or more corner conduit segments, each comprising a bend of a predetermined angle (for example, 22.5 degrees); and a plurality of joint connectors configured to interconnect the straight conduit segments and the one or more corner conduit segments to form an enclosed pathway for routing one or more cables or wires with or without access points or junction boxes within the pathway.

Certain aspects provide a corner conduit assembly, comprising: a first conduit segment having a first end and a second end; a second conduit segment having a first end and a second end; and a swiveling connector interconnecting the second end of the first conduit segment to the first end of the second conduit segment, the swiveling connector configured to allow the first conduit segment and the second conduit segment to rotate relative to each other while maintaining an enclosed pathway through the first conduit segment, the swiveling connector, and the second conduit segment.

Certain aspects provide a conduit connector assembly comprising: a first conduit segment having a first end and a second end; a second conduit segment having a first end and a second end; a male coupling portion disposed at the second end of the first conduit segment, the male coupling portion comprising a first cylindrical body; a female coupling portion disposed at the first end of the second conduit segment, the female coupling portion comprising a second cylindrical body configured to receive the first cylindrical body; and one or more sealing elements disposed between the first cylindrical body and the second cylindrical body, the one or more sealing elements configured to form a sealed connection between the first conduit segment and the second conduit segment.

Certain aspects provide a locking conduit connector comprising: a first coupling element configured to connect to a first conduit segment; a second coupling element configured to connect to a second conduit segment; and a locking mechanism configured to secure the first coupling element to the second coupling element and prevent accidental disconnection between the first conduit segment and the second conduit segment.

Certain aspects provide a pre-assembled cable and conduit system, comprising: a plurality of cable bundles, each cable bundle comprising a plurality of cables pre-cut to a predetermined length based on building plans and specifications; and a plurality of conduit assemblies, each conduit assembly comprising one or more conduit segments pre-cut to a predetermined length based on the building plans and specifications, wherein the plurality of cable bundles are pre-installed within the plurality of conduit assemblies to form a pre-assembled cable and conduit system. In some instances, the conduit clamp may be a single piece that can be installed over adjacent conduit section ends and then fixed in place.

Certain aspects provide a cable bundle pulling system for installing a cable bundle onto a data cable tray system, the cable bundle pulling system comprising: a series of pulleys configured to attach to the data cable tray system at strategic locations; and a cable bundle pull force detection device configured to monitor a pulling force applied to the cable bundle during installation; wherein the series of pulleys is configured to guide and support the cable bundle during installation onto the data cable tray system, and the cable bundle pull force detection device is configured to ensure that the pulling force does not exceed a maximum allowable pulling force for the cable bundle.

Certain aspects provide a cable bundle pulling system for installing a cable bundle onto a data cable tray system, the cable bundle pulling system comprising: a series of pulleys configured to attach to the data cable tray system at strategic locations, wherein the series of pulleys is configured to guide and support the cable bundle during installation onto the data cable tray system.

Certain aspects provide a conduit clamp cover for enclosing a cable bundle within a conduit assembly, the conduit clamp cover comprising: a first half and a second half configured to mate together and enclose a portion of the conduit assembly; a flexible, durable material forming the first half and the second half; and a snap-fit mechanism configured to securely connect the first half and the second half around the conduit assembly.

Certain aspects provide a method for automating installation planning of a cable and/or wire management system, the method comprising: receiving, by a computing device, building plans and specifications for a building; analyzing, by the computing device, the building plans and specifications to identify a plurality of cable and/or wire runs and a plurality of conduit runs; grouping, by the computing device, the plurality of cable and/or wire runs into one or more bundles based on a set of predetermined criteria; generating, by the computing device, a bill of materials (BOM) for the cable and/or wire management system based on the one or more bundles and the plurality of conduit runs; generating, by the computing device, a set of installation instructions for the cable and/or wire management system based on the one or more bundles and the plurality of conduit runs; and outputting, by the computing device, the BOM and the set of installation instructions. In some instances, the set of installation instructions may include drawings that may be used for fabrication.

Certain aspects provide a method for automating installation planning of a cable and/or wire management system, the method comprising: receiving, by a computing device, building plans and specifications for a building; analyzing, by the computing device, the building plans and specifications to identify a plurality of cable and/or wire runs; grouping, by the computing device, the plurality of cable and/or wire runs into one or more bundles based on a set of predetermined criteria; generating, by the computing device, a bill of materials (BOM) for the cable and/or wire management system based on the one or more bundles; generating, by the computing device, a set of installation instructions for the cable management system based on the one or more bundles; and outputting, by the computing device, the BOM and the set of installation instructions. In some instances, the set of installation instructions may include drawings that may be used for fabrication.

Certain aspects provide a method for factory pre-assembly of a cable and/or wire management system, the method comprising: pre-cutting a plurality of cables and/or wires to predetermined lengths based on an installation plan; bundling the plurality of cables and/or wires together to form one or more bundles; establishing one or more conduit assemblies, each conduit assembly comprising a plurality of conduit segments; and pulling the one or more bundles through the one or more conduit assemblies to generate a factory fabricated conduit run. In some aspects, the method may include terminating at least one end of each of the plurality of cables and/or wires with one or more connectors.

Certain aspects provide a method for factory pre-assembly of a cable and/or management system, the method comprising: pre-cutting a plurality of cables and/or wires to predetermined lengths based on an installation plan; bundling the plurality of cables and/or wires together to form one or more bundles. In some aspects, the method may include terminating at least one end of each of the plurality of cables and/or wires with one or more connectors.

Certain aspects provide a method for modular installation of a cable and/or wire management system, the method comprising: delivering a plurality of pre-assembled cable and/or wire bundles to an installation site, wherein the pre-assembled cable and/or wire bundles are installed according to a factory process; delivering a plurality of conduit components to the installation site; routing the plurality of pre-assembled cable and/or wire bundles through the plurality of conduit components to form a cable and/or wire management system; and connecting the plurality of pre-assembled cable and/or wire bundles to a plurality of endpoints according to an installation plan.

Certain aspects provide a method for modular installation of a cable and/or wire management system, the method comprising: delivering a plurality of pre-assembled cable and/or wire bundles to an installation site, wherein the pre-assembled cable and/or wire bundles are installed according to a factory process; and connecting the plurality of pre-assembled cable and/or wire bundles to a plurality of endpoints according to an installation plan.

Certain aspects provide a method for modular installation of a cable and/or wire management system, the method comprising: delivering a plurality of pre-assembled cable and/or wire bundles to an installation site, wherein the pre-assembled cable and/or wire bundles are assembled according to a factory pre-assembly process; delivering a plurality of conduit components to the installation site; routing the plurality of pre-assembled cable and/or wire bundles through the plurality of conduit components to form a cable and/or wire management system; and connecting the plurality of pre-assembled cable and/or wire bundles to a plurality of endpoints according to an installation plan.

Certain aspects provide a method for modular installation of a cable and/or wire management system, the method comprising: delivering a plurality of pre-assembled cable and/or wire bundles to an installation site, wherein the pre-assembled cable and/or wire bundles are assembled according to a factory pre-assembly process; and connecting the plurality of pre-assembled cable and/or wire bundles to a plurality of endpoints according to an installation plan.

Certain aspects provide a method for integrated quality control and testing of a cable management system during a factory manufacturing process, the method comprising: monitoring, using a software tool, a plurality of quality control checkpoints during the factory manufacturing process; performing, using a testing equipment, a plurality of tests on a plurality of cable assemblies at predetermined stages of the factory manufacturing process; analyzing, using the software tool, data collected from the plurality of quality control checkpoints and the plurality of tests; identifying, using the software tool, quality control issues or test failures; and generating, using the software tool, a quality control report for each of the plurality of cable assemblies. In some aspects, the method may include labeling one or more ends of a cable assembly to match installation plans.

Certain aspects provide a method of installing a modular conduit assembly, comprising: providing a modular conduit assembly in a shipping configuration, the modular conduit assembly including: a plurality of straight conduit segments, and a plurality of corner conduit segments; unfolding the modular conduit assembly from the shipping configuration to form an elongated conduit assembly; and installing the elongated conduit assembly at an installation site to form a continuous, enclosed pathway for routing one or more cables.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIGS. 1A and 1B illustrate perspective views of the conduit assembly, depicting the structure and arrangement of its components, including straight and curved conduit segments, in accordance with examples of the present disclosure.

FIG. 2 illustrates a detailed view of a curved conduit segment configured with swiveling joints at each end, in accordance with examples of the present disclosure.

FIG. 3 illustrates an exploded view of a swiveling joint or coupling, in accordance with examples of the present disclosure.

FIG. 4 illustrates a detailed view of a swiveling joint for straight conduit segments, in accordance with examples of the present disclosure.

FIG. 5 illustrates a view of one or more conduit assemblies being installed within a structure, in accordance with examples of the present disclosure.

FIG. 6 illustrates a snap-on cover for enclosing and protecting a cable bundle within the conduit assembly, as well as for connecting ends of unfolded pre-wired conduit and repairing broken conduit, in accordance with examples of the present disclosure.

FIG. 7 illustrates a perspective view of a pulley designed for use in unrolling and guiding a cable or conduit assembly bundle during installation, in accordance with examples of the present disclosure.

FIG. 8 illustrates a schematic view of an example space featuring raceways or routed cabling pathways for installing a cable assembly bundle, with an enlarged view of the arrangement of the bundle and pulleys, in accordance with examples of the present disclosure.

FIG. 9 illustrates a perspective view of a multiple pulley system in a stacked configuration for guiding and supporting a cable or conduit assembly bundle during installation, in accordance with examples of the present disclosure.

FIG. 10 illustrates a side view of a cable or conduit assembly routing system highlighting the use of multiple pulleys in various configurations to guide and support the bundle as it transitions between horizontal and vertical orientations, in accordance with examples of the present disclosure.

FIG. 11 depicts a detailed illustration of a palletized cable bundle system highlighting various configurations and arrangements of pre-assembled cable and conduit assemblies designed to streamline shipping, handling, and installation processes, in accordance with examples of the present disclosure.

FIG. 12 illustrates a flow diagram of a method for generating electrical and cable assemblies for a building project, detailing steps for preparing architectural plans and executing the creation of infrastructure, in accordance with examples of the present disclosure.

FIG. 13 illustrates a method for planning and preparing the installation of telecommunications infrastructure in a building project, including steps for calculating paths, obtaining approvals, and documenting processes, in accordance with examples of the present disclosure.

FIGS. 14A and 14B illustrate a method for planning and preparing the installation of electrical infrastructure in a building project, detailing steps for determining components, assigning circuits, and creating documentation, in accordance with examples of the present disclosure.

FIGS. 15A, 15B, and 15C illustrate a method for the fabrication and testing of cable bundles for telecommunications and electrical infrastructure, detailing steps from receiving production output to preparing items for shipment, in accordance with examples of the present disclosure.

FIG. 16 illustrates a computing system utilized to execute various methods related to planning, fabricating, and testing cable bundles for telecommunications and electrical infrastructure, in accordance with examples of the present disclosure.

FIG. 17 illustrates a networked computing environment used for planning, fabricating, and testing cable bundles, including interconnected components and data exchange processes, in accordance with examples of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for efficiently routing and protecting cables and wires in buildings and structures through modular conduit assemblies and data cable trays.

Aspects of the present disclosure outlines a comprehensive approach to the installation and management of various types of cabling and wiring infrastructure, including telecommunications, power, low voltage, and control cabling. This approach leverages modular conduit assemblies with interchangeable segments and advanced coupling mechanisms to allow for flexible and efficient routing of cables. By simplifying the installation process and incorporating advanced tools and methods for planning, fabricating, and testing cable bundles, this system reduces installation time and labor costs while enhancing overall system reliability and performance.

Traditional cable and wire installation methods present several technical challenges. The process is labor-intensive and time-consuming, requiring skilled electricians to manually pull individual, or multiple, cables through conduits, measure and cut each cable to length, and terminate each end with specialized tools. These manual processes are prone to inconsistencies and errors, which can lead to system performance issues and increased maintenance needs. Additionally, the physical demands and ergonomic risks associated with manual cable pulling can pose significant challenges to electricians, potentially leading to workplace injuries.

The technical solutions provided in this disclosure include modular conduit assemblies composed of straight and curved segments that can be easily connected using advanced coupling mechanisms, such as swiveling joints and snap-fit connectors. These features enable quick and flexible routing of cables around obstacles and through confined spaces. Additionally, the system may incorporate a pulley mechanism for unrolling and guiding cable bundles during installation, reducing physical strain on electricians and to support limiting pulling force applied to cables and wires that have a pull force restriction. In some aspects, one or more solutions may also include methods for pre-fabricating and testing cable bundles in a controlled environment, ensuring consistency and high quality before installation. These pre-fabricated bundles can be efficiently deployed on-site, further streamlining the installation process.

In some aspects, the technical solutions provided in this disclosure include pre-bundled wire assemblies. In some aspects, one or more solutions may also include methods for pre-fabricating and testing wire assemblies in a controlled environment, ensuring consistency and high quality before installation. These pre-bundled wire assemblies can be efficiently deployed on-site, further streamlining the installation process.

The benefits of the technical solutions are numerous. Modular conduit assemblies and factory bundled cable and wire assemblies reduce installation time and labor costs by simplifying the routing process and minimizing the need for manual cable pulling. The advanced coupling mechanisms ensure secure and reliable connections, enhancing system performance and reducing maintenance requirements. The pulley system improves ergonomics and safety for electricians by lessening physical strain and reducing the risk of injury. Pre-fabricating and testing cable bundles in a controlled environment ensures high-quality installations, reducing the likelihood of errors and the need for rework. Overall, these solutions provide a more efficient, reliable, and cost-effective approach to managing cable and wire installations in building projects.

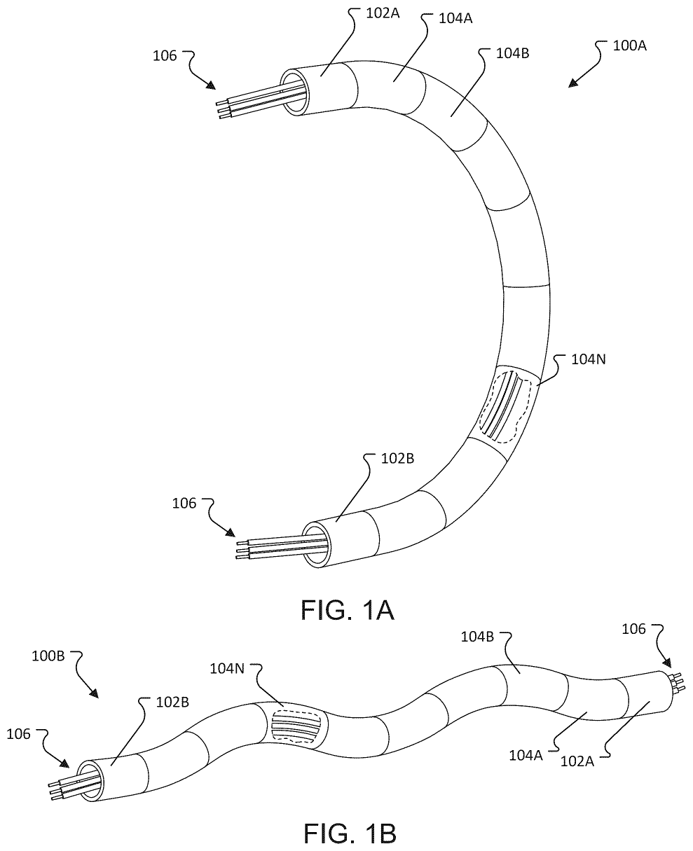

FIGS. 1A and 1B illustrate a conduit assembly 100 for routing and protecting one or more cables and/or wires, according to examples of the present disclosures. More specifically, FIGS. 1A and 1B provide perspective views of the conduit assembly 100, depicting an overall structure and arrangement of the various components of the conduit assembly 100. In aspects, the conduit assembly 100A/100B comprises a plurality of interconnected conduit segments, including straight conduit segments (102A, 102B) and curved conduit segments (104A-104N), forming a continuous, enclosed pathway for one or more cables and/or wires. In examples, a straight conduit segment 102A is positioned at a first end of the conduit assembly 100. The straight conduit segment 102A may be a hollow, cylindrical tube designed to accommodate and protect a portion of the one or more cables and/or wires being routed through the conduit assembly 100. The straight conduit segment 102A may include a uniform cross-section along its length, allowing for the unimpeded passage of the cables and wires, for example wire assembly 106. The length and diameter of the straight conduit segment 102A may be selected based on the specific application and the number and size of the one or more cables and/or wires being routed.

In some examples, at an opposite end of the conduit assembly 100A, straight conduit segment 102B is positioned. Similar to straight conduit segment 102A, straight conduit segment 102B can be a hollow, cylindrical tube designed to accommodate and protect a portion of the one or more cables and/or wires. In examples, straight conduit segment 102B shares the same cross-sectional dimensions as straight conduit segment 102A, ensuring a consistent and continuous pathway for the one or more cables and/or wires throughout the conduit assembly 100A.

Between straight conduit segments 102A and 102B, a plurality of curved conduit segments 104A-104N are positioned. Each of the curved conduit segments 104A-104N is a hollow, tubular component with a predetermined bend radius, allowing the conduit assembly 100 to navigate around obstacles, corners, or changes in direction. The bend radius of each curved conduit segment 104A-104N can be selected to ensure that the minimum bend radius requirements of the one or more cables and/or wires being routed are met, preventing damage or performance degradation. The number and arrangement of curved conduit segments 104A-104N may vary depending on the specific routing path and the layout of the building or structure in which the conduit assembly 100A is installed.

The straight conduit segments 102A, 102B and the curved conduit segments 104A-104N may be made from various materials, depending on the specific application and the environment in which the conduit assembly 100A is installed. Common materials for conduit segments include, but are not limited to, metal (such as steel or aluminum), plastic (such as PVC or HDPE), or composite materials. The choice of material depends on factors such as mechanical strength, corrosion resistance, fire resistance, and cost. In some embodiments, the straight conduit segments 102A, 102B and the curved conduit segments 104A-104N may be made from the same material, while in other embodiments, different materials may be used for different segments of the conduit assembly 100A.

The straight conduit segments 102A, 102B and the curved conduit segments 104A-104N may be coupled together using one or more coupling means. These coupling means may include, but are not limited to, swivel joints, pivot joints, threaded connectors, snap-fit connectors, compression fittings, adhesive bonding, and/or combinations thereof. Swivel joints and pivot joints allow for relative rotation between the connected conduit segments, providing flexibility in the routing path and facilitating installation in confined spaces. Threaded connectors and snap-fit connectors provide a secure, mechanical connection between the conduit segments, while compression fittings and adhesive bonding offer a permanent, fixed connection. The choice of coupling means depends on factors such as the desired level of flexibility, the required strength of the connection, and the ease of installation and maintenance. In some examples, different coupling means may be used at different points along the conduit assembly 100A, depending on the specific requirements of each connection point. In some examples, the conduit assembly 100A may comprise the same coupling means throughout. In some examples, the conduit assembly 100A may comprise a mix of coupling means.

It should be noted that the specific configuration of the conduit assembly 100A shown in FIG. 1A is merely exemplary, and various modifications and variations are possible within the scope of the present invention. For example, while the straight conduit segments 102A, 102B are shown as having straight ends, in some embodiments, one or both ends of the straight conduit segments may be curved or angled to accommodate specific routing requirements. Additionally, the number, arrangement, and bend radii of the curved conduit segments 104A-104N may differ from what is shown in FIG. 1A, depending on the particular application and the desired routing path of the conduit assembly 100A. Furthermore, the composition of the conduit assembly 100A may include more, fewer, or different components than those illustrated, such as additional straight or curved conduit segments, junction boxes, or other accessories, as required by the specific installation.

As depicted in FIG. 1A and FIG. 1B, at the first end of the conduit assembly 100A/100B, a wire assembly 106 is shown. Wire assembly 106 represents the one or more cables and/or wires that are being routed through the conduit assembly 100A/100B. These one or more cables and/or wires may include telecommunications cables, power cables, low voltage cables, control cables, or any combination thereof. In examples, the wire assembly 106 is inserted into the conduit assembly 100A/100B through a straight conduit segment 102A and is protected and guided by the interconnected conduit segments 102-104 along the entire routing path. The composition and arrangement of the one or more cables and/or wires within the wire assembly 106 may vary depending on the specific application and the systems being served by the conduit assembly 100A/100B. In some examples, the wire assembly 106 is inserted into the conduit assembly 100A/100B through a swivel and/or angled connector, such as a curved conduit segment 104A-104N.

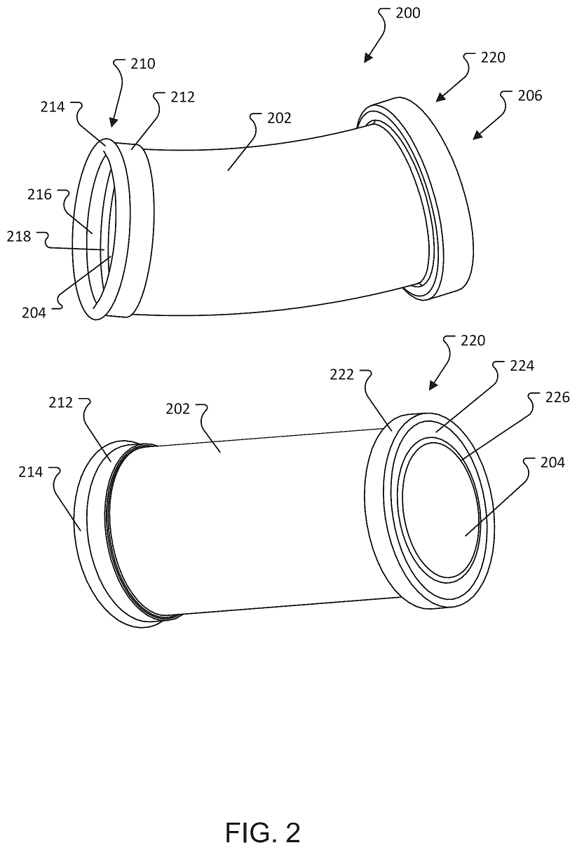

FIG. 2 illustrates a detailed view of an example curved conduit segment 200 configured with a swiveling joint, or coupling, at each end, according to an example of the present disclosure. The curved conduit segment 200 may be the same as or similar to a curved conduit segment 104 of FIG. 1A and/or FIG. 1B. The curved conduit segment 200 can include a plug or male coupling portion 210 at one end and a socket or female coupling portion 220 at the opposite end, allowing for a swiveling connection between adjacent conduit segments. The swiveling joint may enable the curved conduit segment 200 to be rotated and oriented as needed during installation, providing flexibility in routing the conduit assembly. In some examples, the swiveling joint may rotate 360 degrees. In some examples, a wire assembly, such as the wire assembly 106, may be inserted into the curved conduit segment 104.

As shown in FIG. 2, the curved conduit segment 200 can have an outer diameter 202 and an inner diameter 204. The outer diameter 202 represents the external dimension of the curved conduit segment 200, while the inner diameter 204 defines the internal passage through which the cables or wires are routed. The dimensions of the outer diameter 202 and inner diameter 204 may be selected based on the specific application, the number and size of the cables or wires being accommodated, and the required mechanical strength of the conduit segment.

At one end of the curved conduit segment 200, a plug or male coupling portion 210 is provided. The plug or male coupling portion 210 is designed to be inserted into a corresponding socket or female coupling portion of an adjacent conduit segment, creating a secure and rotatable connection. The plug or male coupling portion 210 includes a first portion 212 and a second portion 214. The first portion 212 has a diameter that closely matches the inner diameter of the socket or female coupling portion, ensuring a snug fit when inserted. The second portion 214 of the plug or male coupling portion 210 may have a reduced diameter compared to the recess portion 224 of the socket or female coupling portion 220. This difference in diameters allows the second portion 214 to be inserted into and securely engaged by the recess portion 224.

When the plug or male coupling portion 210 is inserted into the socket or female coupling portion 220, the second portion 214 can enter the recess portion 224. The recess portion 224 may have a larger diameter than the second portion 214, creating a pocket or cavity that captures and retains the second portion 214. This engagement between the second portion 214 and the recess portion 224 can form a secure snap-fit or interference fit connection, preventing accidental disconnection of the conduit segments.

The reduced diameter of the second portion 214 relative to the recess portion 224 can also allow for easier insertion and removal of the plug or male coupling portion 210 from the socket or female coupling portion 220. The clearance between the second portion 214 and the recess portion 224 helps to ensure that the plug or male coupling portion 210 can be easily inserted and extracted without binding or excessive force.

The plug or male coupling portion 210 also features a recess portion 216 located between the first portion 212 and the second portion 214. The recess portion 216 may be a groove or indentation that provides a seating surface for a retaining element, such as a snap ring or a locking collar, to securely hold the plug or male coupling portion 210 within the socket or female coupling portion when assembled.

At the base of the plug or male coupling portion 210, a stop portion 218 may be located. The stop portion 218 can serve as a physical limit to the insertion depth of the plug or male coupling portion 210 into the socket or female coupling portion. When the plug or male coupling portion 210 is fully inserted, the stop portion 218 can contact the end of the socket or female coupling portion 220, preventing further insertion and ensuring proper alignment of the conduit segments. In some examples, the stop portion 218 may correspond to an end of a conduit component where the conduit component is not integrally formed with the plug or male coupling portion 210.

At the opposite end of the curved conduit segment 200, a socket or female coupling portion 220 may be provided. The socket or female coupling portion 220 can be designed to receive and retain the plug or male coupling portion 210 of an adjacent conduit segment, forming a secure and rotatable connection. The socket or female coupling portion 220 can include an outer portion 222 and a recess portion 224. The outer portion 222 may have an inner diameter that is greater than the diameter of the second portion 214 of the plug or male coupling portion 210, creating a snug fit when the plug or male coupling portion 210 is inserted into the socket or female coupling portion 220.

The recess portion 224 of the socket or female coupling portion 220 can be a groove or indentation located between the inner portion 222 and 226. The recess portion 224 can be configured to receive and retain the second portion 214 of the plug or male coupling portion 210 when the conduit segments are assembled. The recess portion 224 may have a diameter or depth that is slightly larger than the diameter of the second portion 214, allowing for a secure snap-fit or interference fit between the plug or male coupling portion 210 and the socket or female coupling portion 220.

Within the socket or female coupling portion 220, an inner portion 226 may be located. The inner portion 226 can have a diameter that closely matches the inner diameter 204 of the curved conduit segment 200, providing a smooth and continuous passage for the cables or wires being routed. In some examples, the inner portion 226 may correspond to an end of a conduit component where the conduit component is not integrally formed with the socket or female coupling portion 220.

The plug or male coupling portion 210 and the socket or female coupling portion 220 can be integrally formed with the curved conduit segment 200. This means that the coupling portions can be manufactured as part of the conduit segment itself, rather than being separate components that are attached later. The integral formation can help to ensure a strong and reliable connection between the conduit segments and can simplify the installation process by reducing the number of parts required.

When the plug or male coupling portion 210 is inserted into the socket or female coupling portion 220, the second portion 214 of the plug or male coupling portion 210 may be received into the recess portion 224 of the socket or female coupling portion 220. The recess portion 224 can be configured to securely hold the second portion 214 in place, preventing accidental disconnection of the conduit segments. The engagement between the second portion 214 and the recess portion 224 can create a snap-fit or interference fit, which can be further enhanced by the use of retaining elements such as snap rings or locking collars.

As the plug or male coupling portion 210 is fully inserted into the socket or female coupling portion 220, the stop portion 218 of the plug or male coupling portion 210 can come into contact with the inner portion 226 of the socket or female coupling portion 220. This contact between the stop portion 218 and the inner portion 226 can serve as a physical limit to the insertion depth, ensuring that the conduit segments are properly aligned and securely connected.

The swiveling joint formed by the plug or male coupling portion 210 and the socket or female coupling portion 220 can allow for relative rotation between the connected conduit segments. This rotational freedom enables the conduit assembly to be easily adjusted and oriented during installation, accommodating changes in routing direction or navigating around obstacles. The swiveling joint also helps to reduce stress and strain on the cables or wires being routed, as it allows for a smooth and gradual transition between conduit segments.

In some examples, the swiveling joint may be designed as a compression fitting. In a compression fitting, the plug or male coupling portion 210 can be inserted into the socket or female coupling portion 220, and a compression nut or collar is tightened around the socket or female coupling portion 220. As the compression nut or collar is tightened, it may compress the socket or female coupling portion 220 onto the plug or male coupling portion 210, creating a secure and, in some instances, water-tight seal. Compression fittings can provide a strong and reliable connection between conduit segments and are particularly useful in applications where a high degree of environmental protection is required.

The curved conduit segment 200 with its swiveling joint at each end, can provide a versatile and adaptable component for the conduit assembly. The swiveling joint can allow for easy installation and adjustment of the conduit routing, while maintaining a secure and reliable connection between conduit segments. The integral formation of the coupling portions with the conduit segment can help to ensure a robust and durable construction, reducing the risk of connection failure or leakage. The combination of the plug or male coupling portion 210 and the socket or female coupling portion 220, along with the use of retaining elements and compression fittings, can create a highly effective and efficient means of joining conduit segments in a modular and flexible manner.

The swiveling joint formed by the plug or male coupling portion 210 and the socket or female coupling portion 220 can be secured using various connection methods, depending on the specific application and requirements. These connection methods may include, but are not limited to, rotation, insertion, crimping, bolting, snap locking (using snap rings), gluing, quick disconnects (similar to air hose fittings), threading, and sleeve connectors. Each of these methods can provide a secure and reliable connection between the conduit segments, while allowing for the necessary rotational movement of the swiveling joint.

In addition to the connection methods, the curved conduit segment 200 can be adapted to work with different types of conduit materials, depending on the application. For example, the curved conduit segment 200 can be designed to accommodate flexible conduit types, such as liquidtight® (ultratite®) conduit, steel flexible conduit, or other flexible conduits with appropriate end connectors. These flexible conduit types can provide additional versatility and adaptability to the conduit assembly, allowing it to navigate through tight spaces or around obstacles more easily. In some aspects, flexible conduit may be used in place of one or more curved conduit segments 200.

The choice of connection method and conduit type can be based on factors such as the environment in which the conduit assembly will be installed, the required level of protection for the cables or wires, the desired degree of flexibility, and the ease of installation and maintenance. By offering a range of connection options and compatibility with various conduit types, the curved conduit segment 200 with its swiveling joint can provide a highly adaptable and customizable solution for routing and protecting cables and wires in a wide variety of applications.

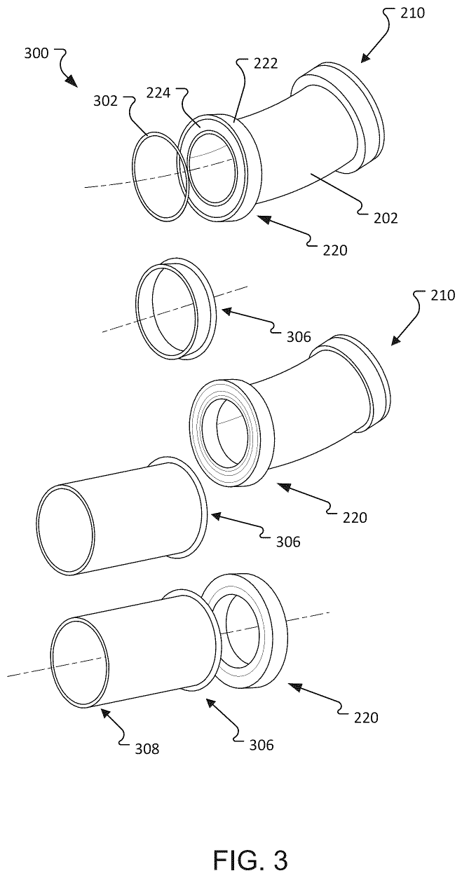

FIG. 3 illustrates an exploded view of a swiveling joint 300 or coupling, according to an example of the present invention. The swiveling joint 300 may be used to connect adjacent conduit segments, such as the curved conduit segment 200 shown in FIG. 2, allowing for relative rotation between the connected segments. The exploded view provides a detailed look at the individual components that make up the swiveling joint 300, including sealing elements, retaining features, and the male and female coupling portions.

As shown in FIG. 3, the swiveling joint 300 may include an O-ring or seal 302. The O-ring or seal 302 is a sealing element designed to create a seal between an adjacent male coupling portion (e.g., male coupling portion 210 of an adjacent conduit segment 102/104 of FIG. 1, 200 of FIG. 2, or another coupling portion of another segment or attachment) and the female coupling portion 220 when the swiveling joint 300 is assembled. The O-ring or seal 302 can be made of an elastomeric material, such as rubber or silicone, which can deform and compress when the male and female coupling portions are brought together. This deformation allows the O-ring or seal 302 to fill any gaps or irregularities between the mating surfaces, preventing leaks or contamination from entering the conduit system. In some examples, the O-ring or seal 302 is optional.

The male coupling portion 210 of the swiveling joint 300 includes a first portion 306. In examples, the first portion 306 is a cylindrical section that extends from the base of the male coupling portion 210 and is designed to be inserted into the female coupling portion 220. The outer diameter of the first portion 306 is typically sized to create a close, sliding fit with the inner diameter of the female coupling portion 220, allowing for smooth rotation between the connected conduit segments. The first portion 306 may also include features such as grooves, slots, or holes to accommodate sealing elements or retaining features. In some examples, the first portion 306 may correspond to the second portion 214 of FIG. 2.

The female coupling portion 220 of the swiveling joint 300 can be designed to receive and retain the male coupling portion 210. The female coupling portion 220 includes an outer portion 222 that corresponds to the outer portion 222 described in FIG. 2. This outer portion 222 can have an inner diameter that is slightly larger than the outer diameter of the first portion 306 of the male coupling portion 210, creating a clearance fit that allows for easy insertion and removal of the male coupling portion. The outer portion 222 of the female coupling portion 220 may also include features such as grooves or recesses (e.g., 224) to accommodate one or more other fastening elements.

When the swiveling joint 300 is assembled, the male coupling portion 210 is inserted into the female coupling portion 220, with the first portion 306 of the male coupling portion 210 engaging with the corresponding features of the female coupling portion 220. The O-ring or seal 302 may be compressed between the mating surfaces of the coupling portions, creating a tight seal that prevents leaks and contamination. The resulting swiveling joint 300 can provide a strong, flexible connection between adjacent conduit segments, enabling the conduit system to be easily routed and adapted to the specific needs of the application.

End 308, situated opposite to first portion 306, is designed to accept various types of mechanical connectors such as clamps or couplers. This end 308 can act as a universal connector point for securing the conduit to structural components of a building or for connecting to other segments of the conduit system. End 308 can be configured to accommodate threaded, clamped, or glued connections, enabling it to support both metallic and non-metalic conduit types.

The design of the swiveling joint 300, with its optional O-ring or seal 302, adaptable first portion 306, and versatile end 308, reflects an innovative approach to modular conduit design. This design facilitates efficient installation and ensures reliable operation of cable management systems in diverse architectural and environmental conditions, showcasing the invention's commitment to flexibility, security, and durability.

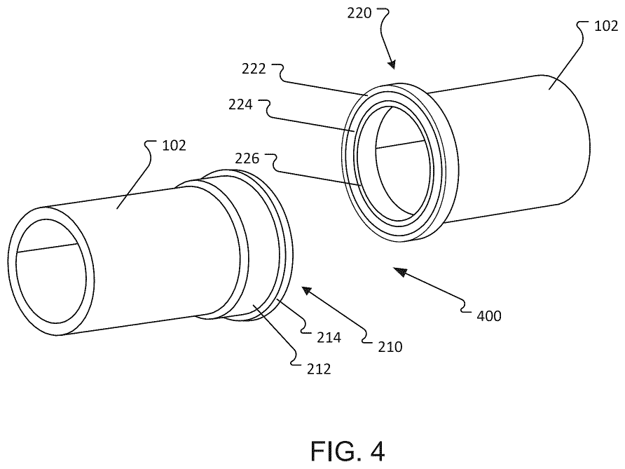

FIG. 4 illustrates a view of a swiveling joint 400 or coupling for one or more straight conduit segments 102, according to an embodiment of the present invention. The swiveling joint 400 can be designed to connect adjacent conduit segments, such as the straight conduit segments 102 and the curved conduit segments 104 shown in FIG. 1A and FIG. 1B, allowing for relative rotation between the connected segments. FIG. 4 depicts a detailed look at the internal structure and arrangement of the male and female coupling portions of a straight conduit segment 102, as well as the sealing and retaining features that ensure a secure and reliable connection.

As shown in FIG. 4, the straight conduit segment 102 can be a hollow, cylindrical tube designed to accommodate and protect a portion of the one or more cables and/or wires being routed through the conduit assembly. The straight conduit segment 102 may have a uniform cross-section along its length, allowing for the unimpeded passage of the cables and wires. The length and diameter of the straight conduit segment 102 may be selected based on the specific application and the number and size of the cables and/or wires being routed.

The swiveling joint 400 also features a socket or female coupling portion 220. The socket or female coupling portion 220 is designed to receive and retain the plug or male coupling portion 210 of an adjacent conduit segment, forming a secure and rotatable connection. The socket or female coupling portion 220 includes an outer portion 222, a recess portion 224, and an inner portion 226.

The outer portion 222 of the socket or female coupling portion 220 has an inner diameter that is slightly larger than the outer diameter of the first portion 212 of the plug or male coupling portion 210. This creates a clearance fit that allows for easy insertion and removal of the plug or male coupling portion 210. The outer portion 222 may also include features such as grooves or recesses to accommodate sealing elements or retaining features, such as O-rings or snap rings.

The recess portion 224 of the socket or female coupling portion 220 is a groove or indentation located between the outer portion 222 and the inner portion 226. The recess portion 224 is designed to receive and retain the second portion 214 of the plug or male coupling portion 210 when the conduit segments are assembled. The recess portion 224 has a diameter or depth that is slightly larger than the diameter of the second portion 214, allowing for a secure snap-fit or interference fit between the plug or male coupling portion 210 and the socket or female coupling portion 220.

The inner portion 226 of the socket or female coupling portion 220 has a diameter that closely matches the inner diameter of the straight conduit segment 102, providing a smooth and continuous passage for the cables or wires being routed. The inner portion 226 may also serve as a stop or limit for the insertion of the plug or male coupling portion 210, ensuring that the conduit segments are properly aligned and seated when assembled.

The plug or male coupling portion 210 of the swiveling joint 400 is designed to be inserted into and engage with the socket or female coupling portion 220 of an adjacent conduit segment. The plug or male coupling portion 210 includes a first portion 212 and a second portion 214.

The first portion 212 of the plug or male coupling portion 210 has an outer diameter that closely matches the inner diameter of the outer portion 222 of the socket or female coupling portion 220. This creates a snug, sliding fit between the plug or male coupling portion 210 and the socket or female coupling portion 220, allowing for smooth rotation while maintaining a secure connection. The first portion 212 may also include features such as grooves or slots to accommodate sealing elements or retaining features.

The second portion 214 of the plug or male coupling portion 210 has a reduced outer diameter compared to the first portion 212, creating a stepped profile. This stepped profile allows the second portion 214 to be inserted into and engage with the recess portion 224 of the socket or female coupling portion 220. The engagement between the second portion 214 and the recess portion 224 creates a secure, interlocking connection that prevents accidental disconnection of the conduit segments and maintains the alignment of the swiveling joint 400.

When the swiveling joint 400 is assembled, the plug or male coupling portion 210 is inserted into the socket or female coupling portion 220, with the first portion 212 and second portion 214 of the plug or male coupling portion engaging with the corresponding features of the socket or female coupling portion. Sealing elements, such as O-rings, may be positioned between the mating surfaces of the coupling portions to create a tight seal that prevents leaks and contamination. Retaining features, such as snap rings or locking collars, may also be used to secure the plug or male coupling portion 210 within the socket or female coupling portion 220 while still allowing for relative rotation. The resulting swiveling joint 400 provides a strong, flexible connection between adjacent conduit segments, enabling the conduit system to be easily routed and adapted to the specific needs of the application.

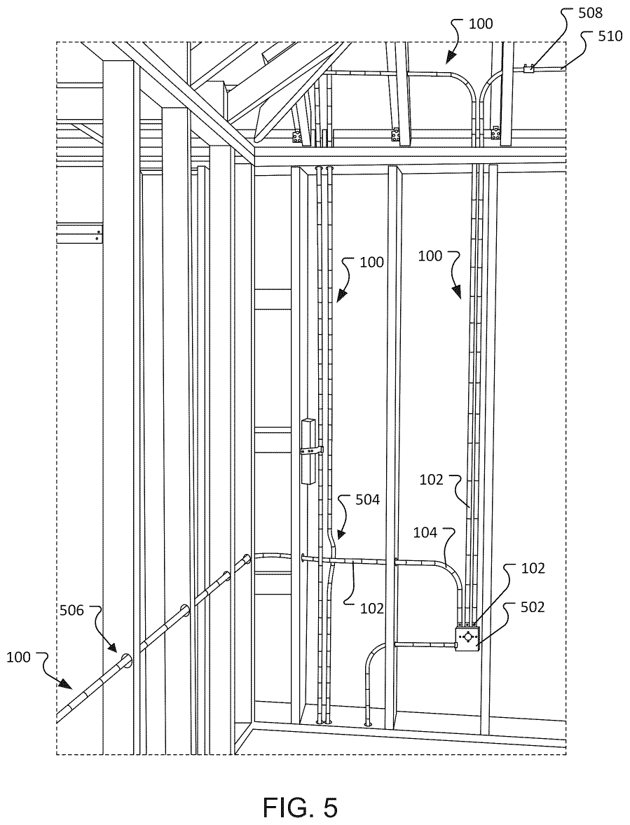

FIG. 5 illustrates a view of one or more conduit assemblies 100 being installed within a structure, such as a building or dwelling, according to an embodiment of the present invention. One or more conduit assemblies 100 are shown in various states of installation, demonstrating the flexibility and adaptability of the system in navigating around obstacles and connecting to existing electrical infrastructure. The view in FIG. 5 can be considered a “rough-in” stage of the installation process, where the one or more conduit assemblies 100 are being routed and secured prior to the installation of drywall, flooring, or other finishing materials.

As shown in FIG. 5, the one or more conduit assemblies 100 may include one or more conduit segments 102 and/or 104. In some examples, a conduit segment 102/104 is connected to a first piece of electrical infrastructure 502. The first piece of electrical infrastructure 502 may be an electrical box, such as a single gang, double gang, or triple gang box, or a breaker box for example. The connection between the conduit segment 102/104 and the first piece of electrical infrastructure 502 can be made using a variety of methods, such as a swiveling joint (as described in FIGS. 2-4), a threaded connector, a compression fitting, or any other suitable means. This connection point serves as a starting or ending point for the conduit assembly 100, allowing it to interface with the existing electrical system of the structure.

The conduit assembly 100 is also shown bending around another conduit assembly at 504. This demonstrates the flexibility of the conduit assembly 100 and its ability to navigate around obstacles and other conduit systems within the structure. The bend in the conduit assembly 100 can be achieved using a curved conduit segment, as described in FIGS. 1A and 1B, or by using a combination of straight conduit segments 102 connected by swiveling joints that allow for relative rotation between the segments. By bending around the other conduit assembly, the conduit assembly 100 can be efficiently routed through the structure without interfering with existing infrastructure.

At another point along its path, the conduit assembly 100 is shown penetrating or otherwise going through a hole 506 in a stud. Studs are vertical structural members, typically made of wood or metal, that form the framework of walls in a building. The conduit assembly 100 can be routed through holes drilled in the studs, allowing it to pass from one side of a wall to the other. The size of the hole 506 in the stud is typically selected to provide a close fit around the conduit assembly 100, minimizing the amount of open space and maintaining the structural integrity of the stud. The conduit assembly 100 may be secured to the stud using clamps, straps, or other fasteners to prevent movement and ensure a stable installation.

Finally, the conduit assembly 100 is shown connecting to another type of conduit 510, such as electrical metallic tubing (EMT), using a coupling or clamp 508. This connection point allows the conduit assembly 100 to interface with other types of conduit systems that may be present in the structure. The coupling or clamp 508 can be a mechanical connector, such as a set-screw coupling or a compression fitting, that provides a secure and reliable connection between the conduit assembly 100 and the conduit 510 (e.g., EMT). By connecting to other conduit systems, the conduit assembly 100 can be integrated into a larger electrical infrastructure, allowing for the efficient distribution of power and communication signals throughout the structure.

The installation scenario depicted in FIG. 5 highlights the versatility and adaptability of the conduit assembly 100 in a real-world application. By utilizing a combination of straight conduit segments 102, curved conduit segments 104, and swiveling joints, the conduit assembly 100 can be easily routed through the structure, navigating around obstacles, passing through structural elements, and connecting to existing electrical infrastructure. The modular nature of the conduit assembly 100 allows for efficient installation and modification, while the secure connections provided by the couplings and clamps ensure a reliable and robust electrical system.

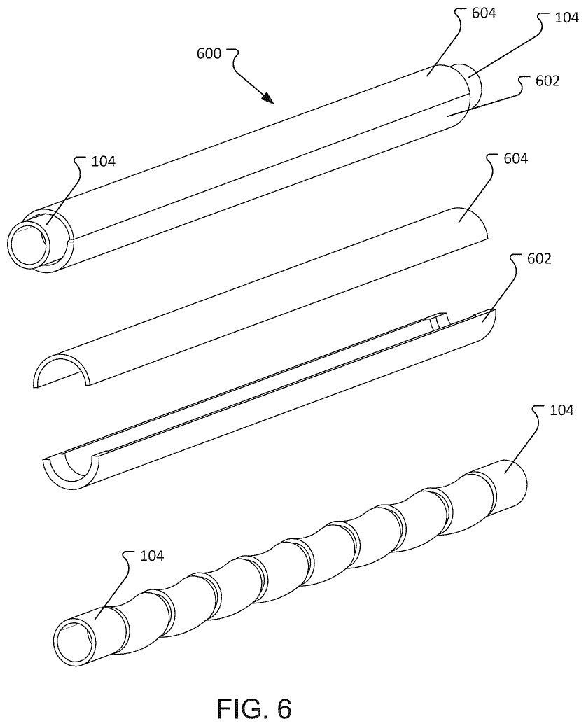

FIG. 6 illustrates a view of a removable, snap-on cover 600 for enclosing and protecting a cable bundle within the straight segments of a conduit assembly, as well as for connecting ends of unfolded and/or pre-assembled conduit and repairing broken conduit, according to an example of the present disclosure. The snap-on cover 600 can provide a secure, yet easily removable, enclosure for the cables and wires being routed through the conduit assembly (e.g., 100 of FIG. 1), shielding them from dust, debris, and unauthorized access. The snap-on cover 600 also serves to enhance the overall appearance of the conduit assembly, providing a clean, finished look to the installation. In some examples, the snap-on cover may be assembled utilizing glue, fasteners (such as bolts, nuts, screws, etc.) and/or other means of connection.

The snap-on cover 600 comprises two halves or portions: a first half 602 and a second half 604. These halves are made of a flexible, durable material that is capable of conforming to the shape of the conduit assembly. The material can be a polymer, such as polyvinyl chloride (PVC), polyethylene, or polypropylene, or a rubber-based compound, such as thermoplastic elastomer (TPE) or silicone. The material should be selected based on its ability to withstand the environmental conditions expected in the installation location, such as temperature fluctuations, humidity, and exposure to ultraviolet (UV) light. Additionally, the material should have sufficient flexibility to allow for easy installation and removal of the snap-on cover 600, while also providing a secure grip on the conduit assembly. In some examples, the snap-on cover 600 may be a unitary piece.

The first half 602 and second half 604 of the snap-on cover 600 are designed to securely grip the conduit assembly when closed together. The two halves may incorporate interlocking features, such as tabs, hooks, or detents, that engage with each other when the halves are pressed together. For example, the first half 602 may include a series of protruding tabs along its edge that align with and snap into corresponding slots or recesses along the edge of the second half 604. When the two halves are closed around the conduit assembly, these interlocking features create a secure, form-fitting connection that prevents the cover from accidentally opening or slipping off the conduit.

In addition to its primary function of enclosing and protecting straight segments of the conduit assembly, the snap-on cover 600 can also be used for connecting the ends of unfolded pre-wired conduit. In this application, the snap-on cover 600 acts as a coupler, joining two separate sections of conduit together. The flexible nature of the cover material allows it to conform to the shape of the conduit ends, creating a secure, weatherproof connection. This feature is particularly useful in situations where a continuous run of pre-wired conduit needs to be installed, but the length of the available conduit sections is insufficient to span the entire distance.

Furthermore, the snap-on cover 600 can serve as a conduit repair coupler, allowing for the quick and easy repair of broken conduit sections. In the event that a section of conduit becomes damaged, such as being crushed or cracked, the damaged portion can be cut away using a saw or other cutting tool. The snap-on cover 600 can then be placed over the two cut ends of the conduit, bridging the gap and restoring the integrity of the conduit run. This repair method eliminates the need for time-consuming and costly replacement of entire conduit sections, minimizing downtime and labor costs.

As an alternative to the two-piece design, the snap-on cover 600 may be constructed as a single, flexible piece that has an opening at each end, allowing it to be pulled and fitted around two adjoining pieces of conduit, such as curved conduit segments 104 and/or straight conduit segments 102 (FIG. 1). In this design, the cover could have a tubular shape with a slit running along its length, enabling it to be opened and wrapped around the conduit sections. The edges of the slit could incorporate interlocking features, such as a tongue-and-groove or a zip-lock style closure, that could securely hold the cover in place once it is closed around the conduit. This single-piece design offers the advantage of a more streamlined installation process, as the cover can be quickly pulled over and secured to the conduit sections without the need for aligning and snapping together separate halves.

The removable, snap-on cover 600, including a first half 602 and a second half 604, is a versatile component of the conduit assembly that serves multiple functions. In addition to providing protection for the cable bundle and enhancing the appearance of the installation, the snap-on cover 600 can also be used for connecting ends of unfolded pre-wired conduit and repairing broken conduit sections. The flexible, durable material and secure interlocking design of the cover allow for easy installation and removal, while ensuring a tight, weatherproof fit around the conduit assembly. The snap-on cover 600 can also be used as a single, flexible piece with openings at each end, allowing it to be pulled and fitted around adjoining conduit sections, such as curved conduit segments 104. By incorporating the snap-on cover 600 into a conduit system, users can benefit from its protective, connective, and repair capabilities, ultimately saving time and labor costs while ensuring a high-quality, professional-grade installation.

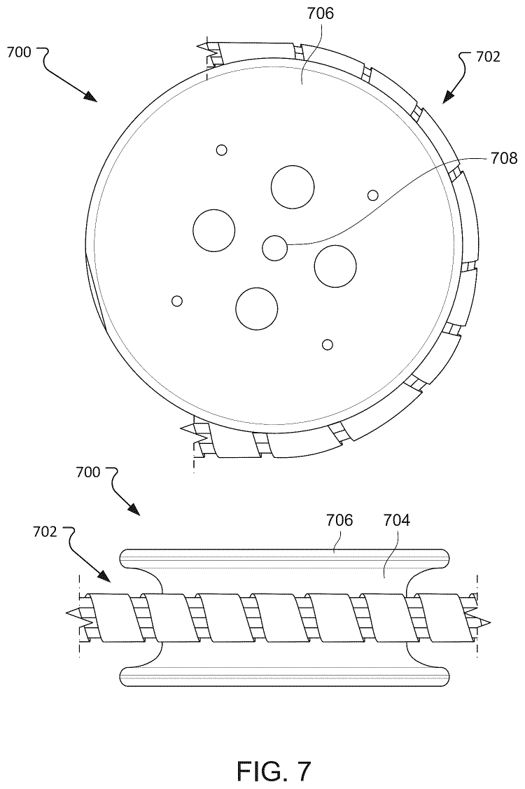

FIG. 7 illustrates a perspective view of a pulley 700 designed for use in unrolling and guiding a cable assembly bundle 702, according to examples of the present disclosure. The pulley 700 is a mechanical device that facilitates the smooth and controlled unrolling of the cable assembly bundle 702 from a cable spool or reel during an installation process. By incorporating the pulley 700 into the cable assembly deployment system, users can efficiently and accurately route the bundled cables to their desired locations within a structure.

The pulley 700 consists of a circular or disc-shaped body that rotates about a central axis 708. The body of the pulley 700 is typically made from a rigid, durable material, such as metal (e.g., steel or aluminum), plastic (e.g., high-density polyethylene or nylon), or a composite material (e.g., fiber-reinforced polymer). The material could be selected based on its strength, wear resistance, and ability to withstand the anticipated loads and environmental conditions encountered during the cable assembly installation process.

Along the outer circumference of the pulley 700, a groove 704 is provided to guide and retain the cable assembly bundle 702. The groove 704 can be a recessed channel that is sized and shaped to accommodate the cross-sectional profile of the bundled cables. The depth and width of the groove 704 should be sufficient to prevent the cable assembly bundle 702 from slipping out of the pulley 700 during operation, while also allowing for smooth and unimpeded rotation of the pulley. In some embodiments, the groove 704 may feature a V-shaped or U-shaped cross-section to better cradle and center the cable assembly bundle 702.

The pulley 700 can support and guide the cable assembly bundle 702, which may include a group of individual cables and/or wires that are bound and/or wrapped together for efficient routing and installation. The cable assembly bundle 702 can be held together using various methods, such as a flexible wrap, to maintain its cohesion and organization. The flexible wrap material can be any substance that is capable of securely holding the bundle of wires and/or cables together while still allowing it to bend and flex as needed during the unrolling and installation process.

In some examples, the cable bundle pulling system further comprises a cable bundle pull force detection device configured to monitor the pulling force applied to the cable bundle during installation. The cable bundle pull force detection device ensures that the pulling force does not exceed a maximum allowable pulling force for the specific type and size of cables within the cable bundle, preventing damage to the cables during the installation process.

The cable bundle pull force detection device can include various types of force sensors, such as load cells, strain gauges, or force transducers, which are capable of measuring the tension or compression forces applied to the cable bundle. The device may be integrated into the pulling system, such as being attached to the pull rope or the cable bundle itself, or it may be a separate unit that is temporarily attached during the installation process. The cable bundle pull force detection device may also feature visual or audible alerts to notify the installation team when the pulling force approaches or exceeds a predetermined threshold, allowing them to adjust the pulling process accordingly. In some cases, the device may be configured to automatically stop the pulling process if the maximum allowable pulling force is reached and/or exceeded, thus providing an additional layer of protection for the cables.

Examples of suitable flexible wrap materials include, but are not limited to: shrink wrap, spiral tape, heat shrink tubing, flexible wire or tie wraps, pull-through flexible tubing, and/or zip wraps. Shrink wrap may be a plastic film that contracts when heated, conforming tightly to the shape of the cable assembly bundle 702. Spiral tape may refer to an adhesive tape that is wound around the bundle in a spiral pattern, providing a secure and flexible hold. Heat shrink tubing may refer to a plastic tubing that shrinks and conforms to the bundle when exposed to heat, creating a tight and protective covering. Flexible wire or tie wraps may refer to thin, flexible wires or plastic ties that are wrapped around the bundle and fastened to maintain its structure. Pull-through flexible tubing may refer to a hollow, flexible tube through which the individual cables and/or wires are pulled, keeping them bundled together.

The cable assembly bundle 702, with its flexible wrap, can be easily coiled and stored on a cable spool or reel for efficient transport and deployment. The flexibility of the wrap material allows the bundle to be tightly wound onto the spool without causing damage or permanent deformation to the individual cables and/or wires. At each end of the pulley 700, an outer end 706 or flange is provided to prevent the cable assembly bundle 702 from laterally slipping off the pulley during operation. The outer ends 706 extend radially outward from the body of the pulley 700, creating a barrier that keeps the bundle 702 centered within the groove 704. The diameter of the outer ends 706 should be larger than the width of the groove 704 to effectively retain the cable assembly bundle 702 on the pulley.

The central axis 708 of the pulley 700 serves as the point around which the pulley rotates. The central axis 708 can be supported by a shaft or bearing system that allows for smooth and low-friction rotation of the pulley. The shaft or bearing system may be mounted on a fixed structure, such as a wall or ceiling, or on a movable frame or stand that can be positioned as needed during the cable assembly installation process. In some embodiments, the pulley 700 may be used in combination with other pulleys to create a system for guiding and routing the cable assembly bundle 702 through complex or extended pathways.

Thus, the pulley 700 is a component of a cable assembly deployment system, designed to facilitate the smooth and controlled unrolling and routing of bundled cables and/or wires during the installation process. The pulley 700 features a durable body with a groove 704 to guide and retain the cable assembly bundle 702, which is held together using a flexible wrap material. The outer ends 706 of the pulley prevent the bundle from slipping off laterally, while the central axis 708 provides a point of rotation for the pulley. By incorporating the pulley 700 into the installation process, users can efficiently and accurately route the cable assembly bundle 702 to its desired location within a structure, saving time and effort while ensuring a high-quality, professional-grade installation.

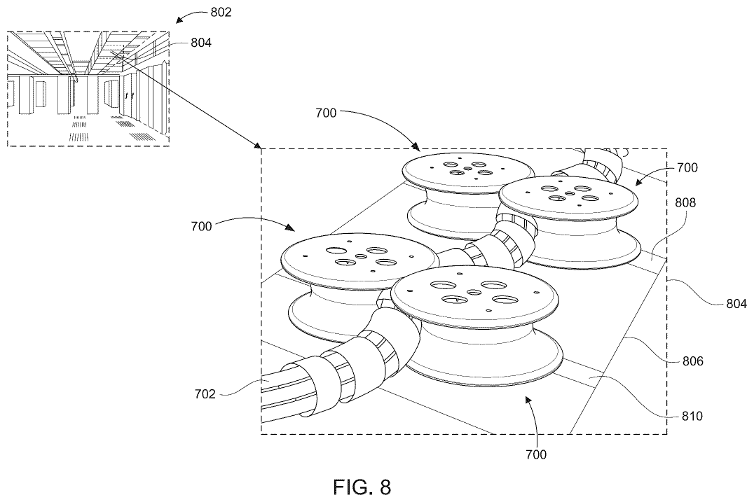

FIG. 8 illustrates a schematic view of an example space 802, such as a room or corridor, featuring one or more raceways or other routed cabling pathways for the installation of a cable assembly bundle 702, according to an example of the present disclosure. FIG. 8 also provides an enlarged view 804 of a portion of the raceway, depicting the arrangement of the cable assembly bundle 702 and the pulleys 700 used to guide and support the bundle during the installation process.

The example space 802 represents a typical environment in which the cable assembly bundle 702 may be installed, such as a commercial or residential building, an industrial facility, or a data center. The space 802 may include various architectural features, such as walls, ceilings, floors, and other structures, through which the raceway or cabling pathway is routed. The raceway or cabling pathway is designed to provide a secure and organized means of distributing the cable assembly bundle 702 throughout the space while protecting it from damage and maintaining a neat and professional appearance.

The enlarged view 804 provides a more detailed look at a section of the raceway or cabling pathway, highlighting the components and arrangement of the cable assembly bundle 702 installation system. Within this enlarged view, the raceway portion or spacing 806 between support portions 810 and/or 808 can be clearly seen. The support portions 810 and 808 are structural elements that are positioned along the raceway or cabling pathway to provide support and guidance for the cable assembly bundle 702. These support portions may be attached to the walls, ceiling, or other stable surfaces within the example space 802, and they serve to maintain the proper alignment and spacing of the raceway portion 806. The support portions 810 and 808 can be made from various materials, such as metal, plastic, or composite, and they may be designed to accommodate different mounting methods, such as screws, bolts, or adhesives, depending on the specific installation requirements.

Within the enlarged view 804, multiple pulleys 700 can be seen guiding and supporting the cable assembly bundle 702 as it is routed along a raceway. The pulleys 700 are positioned at regular intervals along the raceway, typically mounted on or between the support portions 810 and 808. The pulleys 700 serve to reduce friction and provide smooth, low-resistance movement of the cable assembly bundle 702 during the installation process, as well as during any future maintenance or modifications to the cabling system.

As the cable assembly bundle 702 is fed along the raceway, it is guided by the pulleys 700, which help to maintain the proper alignment and prevent the bundle from twisting, kinking, or becoming entangled. The pulleys 700 also help to distribute the weight of the bundle evenly along the raceway, reducing stress on any single point and minimizing the risk of damage to the individual cables and/or wires within the bundle. The use of multiple pulleys 700 in the cable assembly bundle 702 installation system provides several benefits, including: reduced friction and wear on the cable assembly bundle 702, reduced binding on the cable assembly bundle 702, maintains alignment such that the cable assembly bundle 702 does not fall out of the pully, extending its lifespan and maintaining its performance characteristics; easier and more efficient installation process, as the pulleys 700 facilitate the smooth and controlled feeding of the bundle through the raceway; improved organization and management of the cabling system, as the pulleys 700 help to maintain the proper spacing and alignment of the bundle within the raceway; enhanced accessibility for future maintenance, upgrades, or repairs, as the pulleys 700 allow for the easy removal and replacement of individual cables and/or wires within the bundle.

Thus, FIG. 8 provides a schematic overview of an example space 802 featuring a raceway or cabling pathway for the installation of a cable assembly bundle 702, along with an enlarged view 804 depicting the arrangement of the bundle and the pulleys 700 used to guide and support it. The raceway portion 806 between support portions 810 and 808 creates a clear and organized channel for the passage of the bundle, while the multiple pulleys 700 ensure smooth, low-friction movement and proper alignment of the bundle throughout the installation process. By incorporating this pulley-based installation system, users can achieve a high-quality, professional-grade cabling installation that is efficient, reliable, and easy to maintain over time.

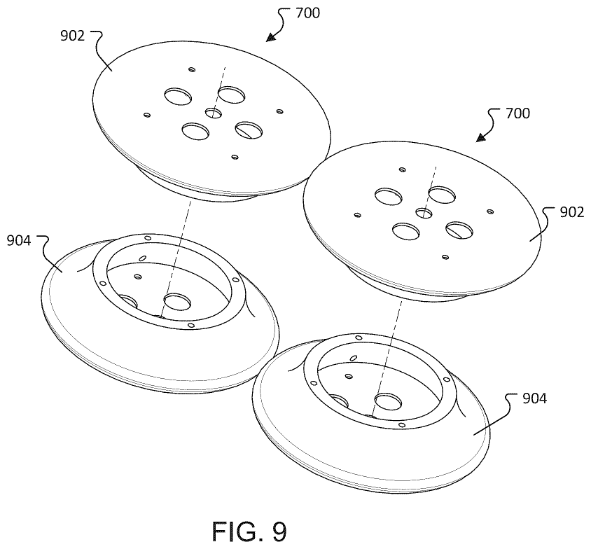

FIG. 9 illustrates a perspective view of a multiple pulley system, featuring two pulleys 700 arranged in a stacked configuration, according to an example of the present disclosure. The multiple pulley system is designed to provide enhanced guidance, support, and organization for the cable assembly bundle 702 during the installation process, particularly in applications where a high degree of control and precision is required, such as in complex or densely packed cabling pathways.

Each pulley 700 in the multiple pulley system consists of two halves: a first half 902 and a second half 904. The first half 902 and second half 904 are designed to be joined together to form a complete pulley 700, enclosing the cable assembly bundle 702 within the pulley's groove (as described in FIG. 7). The two-piece design of the pulley 700 allows for easy installation and removal of the cable assembly bundle 702, as well as simplified maintenance and replacement of the pulleys themselves. In some examples, one or more pulleys may be formed from a single piece of material and/or may be formed of more than two pieces.

The first half 902 of the pulley 700 comprises a semi-circular body with a groove running along its outer edge. The groove is sized and shaped to accommodate the cable assembly bundle 702, providing a secure and low-friction pathway for the bundle to travel through. The first half 902 also features a central opening or bore, which aligns with the corresponding opening in the second half 904 to form the pulley's central axis (708 in FIG. 7). The central opening allows the pulley 700 to be mounted on a shaft or bearing system, enabling smooth rotation of the pulley during operation.

The second half 904 of the pulley 700 is similar in design to the first half 902, featuring a semi-circular body with a groove running along its outer edge. When the first half 902 and second half 904 are joined together, their respective grooves align to form a continuous channel that completely encircles the cable assembly bundle 702. This complete enclosure helps to prevent the bundle from slipping out of the pulley 700 during installation or operation, ensuring a secure and reliable guiding system.

The first half 902 and second half 904 of the pulley 700 can be made from various materials, such as metal (e.g., aluminum or steel), plastic (e.g., nylon or polyethylene), or composite materials (e.g., fiber-reinforced polymer). The choice of material depends on factors such as the anticipated load on the pulley, the environmental conditions of the installation site, and the desired durability and maintenance requirements of the system.

To assemble the pulley 700, the first half 902 and second half 904 are brought together around the cable assembly bundle 702, with the bundle resting within the aligned grooves of the two halves. The two halves can be secured together using various methods, such as snap-fit connections, screws, bolts, or adhesives, depending on the specific design and application requirements. Once assembled, the pulley 700 forms a complete unit that can be mounted on a shaft or bearing system within the cabling pathway, ready to guide and support the cable assembly bundle 702.

The use of multiple pulleys 700 in a stacked configuration, as shown in FIG. 9, offers several advantages over a single pulley system. By distributing the load of the cable assembly bundle 702 across multiple pulleys, the stacked configuration helps to reduce the stress and wear on individual pulleys, extending their lifespan and minimizing maintenance requirements. Additionally, the multiple pulley system provides increased control and precision in guiding the bundle through complex or tightly spaced cabling pathways, as the bundle can be more closely supported and directed by the additional pulleys. Further, the one or more pulleys 700 in a stacked configuration help to ensure the cable assembly bundle will not fall out of the pulley 700.

In summary, FIG. 9 showcases a multiple pulley system, consisting of two pulleys 700 arranged in a stacked configuration, each composed of a first half 902 and a second half 904. This multiple pulley system provides enhanced guidance, support, and organization for the cable assembly bundle 702 during the installation process, particularly in applications requiring a high degree of control and precision. The two-piece design of the pulleys 700 allows for easy installation, removal, and maintenance, while the stacked arrangement offers improved load distribution, increased control, and better organization of different cable types within the bundle. By incorporating this multiple pulley system into the cabling pathway, users can achieve a more efficient, reliable, and maintainable installation, ensuring optimal performance of the cable assembly bundle 702 over its lifetime.

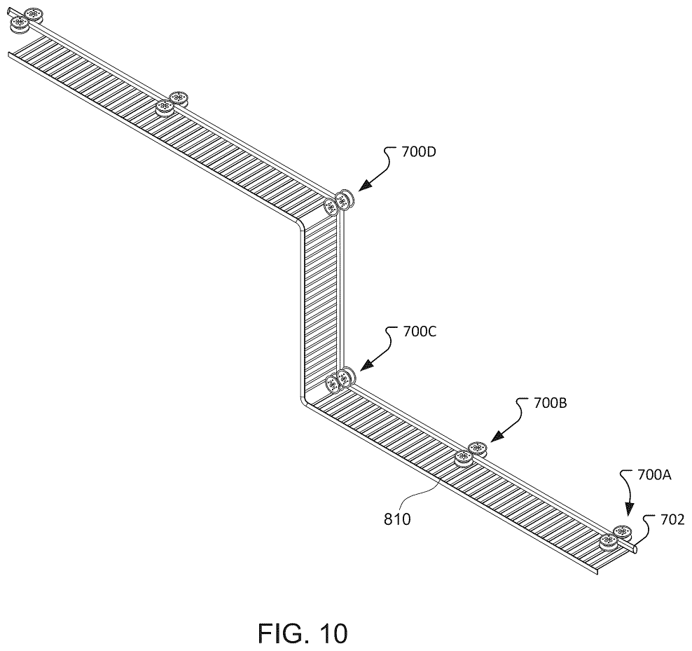

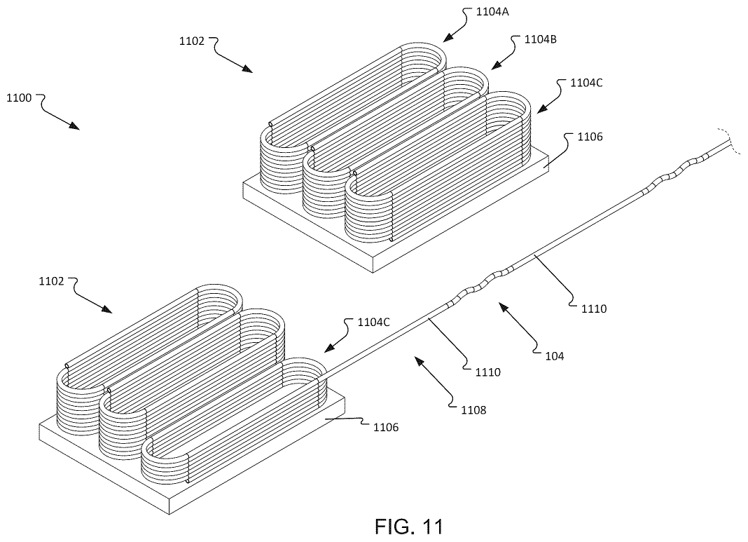

FIG. 10 illustrates a side view of a cable assembly routing system, highlighting the use of multiple pulleys in various configurations to guide and support the cable assembly bundle 702 as it transitions between horizontal and vertical orientations, according to an example of the present disclosure. The routing system depicted in FIG. 10 depicts the versatility and adaptability of the pulley-based approach, enabling the efficient and organized distribution of the cable assembly bundle 702 throughout a building or structure, while accommodating changes in direction and orientation as needed.

The cable assembly routing system features a double pulley configuration, consisting of pulleys 700A and 700B, which are positioned in a horizontal arrangement. The double pulley configuration is designed to guide and support the cable assembly bundle 702 as it travels in a horizontal direction, such as along a raceway pathway running parallel to the floor or ceiling of a room. The use of two pulleys in this horizontal configuration helps to distribute the load of the bundle 702 evenly, reducing stress on individual pulleys and providing a smooth, low-friction pathway for the bundle to travel through.

Pulleys 700A and 700B are mounted on a common shaft or axle, which is supported by brackets or bearing systems (not shown) attached to the surrounding structure, such as the walls or framing members of the building. The pulleys 700A and 700B are spaced apart along the shaft, allowing the cable assembly bundle 702 to pass between them and be guided by the grooves running along their outer edges. The spacing between the pulleys 700A and 700B can be adjusted to accommodate different sizes or configurations of the bundle 702, ensuring a secure and proper fit within the pulley system.

As the cable assembly bundle 702 approaches a change in direction, such as the need to transition from a horizontal orientation to a vertical orientation, a transition pulley 700C can be employed. The transition pulley 700C can be positioned at an angle relative to the horizontal pulleys 700A and 700B, allowing the bundle 702 to smoothly transition from the horizontal pathway to a vertical pathway, such as a raceway running up a wall.

The transition pulley 700C can be designed with a groove or channel that accommodates the change in orientation of the bundle 702, guiding it securely and efficiently through the transition point. The angle and position of the transition pulley 700C can be adjusted to match the specific requirements of the installation, ensuring a smooth and uninterrupted flow of the bundle 702 as it changes direction.

Once the cable assembly bundle 702 has been guided into a vertical orientation by the transition pulley 700C, it may need to transition back to a horizontal orientation at another point in the routing system. To accomplish this, a second transition pulley 700D can be utilized. The transition pulley 700D can be positioned at an angle relative to the vertical pathway, allowing the bundle 702 to smoothly transition back to a horizontal pathway, such as a raceway running along the ceiling or upper portion of a wall.

Like the transition pulley 700C, the transition pulley 700D can include a groove or channel that accommodates the change in orientation of the bundle 702, guiding it securely and efficiently through the transition point. The angle and position of the transition pulley 700D can be adjusted to match the specific requirements of the installation, ensuring a smooth and uninterrupted flow of the bundle 702 as it returns to a horizontal orientation.

The use of transition pulleys 700C and 700D in the cable assembly routing system provides several benefits, including but not limited to: smooth and efficient transitions between horizontal and vertical pathways, minimizing stress and strain on the cable assembly bundle 702; reduced friction and wear on the bundle 702, as the specialized grooves or channels of the transition pulleys guide the bundle securely through the change in orientation; improved organization and control of the routing system, as the transition pulleys help to maintain the proper alignment and positioning of the bundle 702 throughout the installation; and enhanced adaptability and flexibility of the routing system, as the transition pulleys can be easily adjusted or repositioned to accommodate changes in the installation layout or requirements.

Thus, FIG. 10 presents a side view of a cable assembly routing system, highlighting the use of multiple pulleys in various configurations to guide and support the cable assembly bundle 702 as it navigates through horizontal and vertical pathways. The double pulley configuration, consisting of pulleys 700A and 700B, provides a stable and efficient means of guiding the bundle 702 in a horizontal orientation, while the transition pulleys 700C and 700D enable smooth and secure transitions between horizontal and vertical pathways. By incorporating these specialized pulley configurations into the routing system, users can achieve a well-organized, adaptable, and maintainable cable assembly installation, ensuring optimal performance and longevity of the bundled components.

FIG. 11 depicts a detailed illustration of a palletized cable bundle system 1100, highlighting various configurations and arrangements of pre-assembled cable and conduit assemblies designed to streamline the shipping, handling, and installation processes in building projects in accordance with examples of the present disclosure. This palletized cable bundle system 1100 leverages the advantages of factory-assembled cable bundles and conduit assemblies, which can be pre-cut to required lengths and may be pre-terminated with the appropriate connectors based on the specific building plans and specifications.

In examples, the palletized cable bundle system 1100 includes a pallet 1106, a sturdy and reliable base structure that serves as a platform for securely supporting and transporting the cable bundles and conduit assemblies. The pallet 1106 can be manufactured from a range of durable materials, such as high-quality wood, heavy-duty plastic, foam packing material, or robust metal alloys, depending on the specific load-bearing requirements and environmental factors. To ensure optimal maneuverability and ease of transportation, the pallet 1106 may incorporate strategically placed forklift slots or dedicated lifting points, allowing for smooth and efficient movement of the fully loaded system using standard material handling equipment.

Positioned on the pallet 1106 are multiple palletized cable bundles 1102, which may include engineered conduit assemblies 100 that can integrate both straight conduit segments 102 and curved conduit segments 104. In the example depicted in FIG. 11, three distinct cable bundles—1104A, 1104B, and 1104C—are displayed. However, it is important to note that the actual number of cable bundles accommodated by the system can vary significantly depending on the unique requirements of each application and the load capacity of the chosen pallet 1106. These cable bundles may be interconnected to form a continuous, uninterrupted run across the pallet 1106, or they may be arranged as separate, self-contained assemblies to cater to different installation scenarios. In some aspects, the cable bundles 1102 and/or the conduit segments may be prelabeled at one or more ends and/or at one or more intervals to identify a conduit assembly.

In certain aspects, and during installation, the palletized cable bundle system 1100 can include an unrolled portion 1108 of a cable bundle, which can be seen extending from the pallet 1106. This unrolled portion 1108 may comprise a combination of straight conduit segments 1110 and curved conduit segments 104, offering a high degree of flexibility and adaptability in routing the cable bundle during the installation process. The straight conduit segments 1110 can be conceptually similar to the straight conduit segments 102 but may differ in length to accommodate the specific spatial constraints and requirements of the target installation environment. By incorporating both straight and curved conduit segments, the unrolled portion 1108 enables installers to navigate complex pathways and overcome obstacles with ease, ensuring a smooth and efficient deployment of the cable bundle.

In examples, the palletized cable bundle system 1100 can facilitate the unfolding and unpacking of pre-assembled conduit runs with cables already installed, even in challenging and space-constrained environments such as narrow hallways or congested utility corridors. This flexibility is made possible by the use of unfolding conduit connectors, such as the swiveling 180-degree connector, which can be constructed from multiple precisely engineered 22.5-degree sections, flexible conduit, and/or pvc conduit. These connectors can allow the cable bundle to be maneuvered and installed as a cohesive, uninterrupted assembly, eliminating the need for time-consuming on-site modifications and adaptations.

In certain scenarios, the palletized cable bundle system 1100 may be delivered to the installation site without the inclusion of a 90-degree swiveling conduit connector, presenting bare wires at the extremities of the conduit assemblies. This configuration offers the advantage of enhanced customization and flexibility, as the installers can unfold the cable bundle and connect the straight conduit segments 1110 using a simple yet effective sleeve connector or any other suitable fastening mechanism. This approach enables rapid and hassle-free installation of the pre-assembled system, minimizing on-site labor and reducing the potential for errors or delays.

The palletized cable bundle system 1100 can provide the benefit of shipping complete, factory-assembled cable and conduit assemblies that can be swiftly unfolded and installed as a single, unified unit. By eliminating the need for on-site cable cutting, splicing, termination, planning, and manual cable pulling, he palletized cable bundle system 1100 can reduce installation time, labor costs, and equipment expenses, ultimately leading to increased efficiency and cost-effectiveness in building projects.

Moreover, a factory-controlled assembly process can be employed in the creation of the cable bundles and conduit assemblies to ensure quality and consistent performance, as the entire manufacturing workflow can be carried out in a regulated and optimized environment. This approach allows for factory testing of pre-terminated data cables, generating comprehensive test reports for each individual cable and substantially reducing the likelihood of field-terminated rework arising from suboptimal connections or splices. The palletized cable bundle system 1100 also offers the added advantage of pre-numbering or identification tagging at both ends of each cable or wire, greatly simplifying the final connection process and minimizing the potential for errors or confusion during installation. By clearly labeling each component, installers can quickly and accurately identify the corresponding endpoints, streamlining the commissioning phase and ensuring a seamless integration of the cable and conduit assemblies into the overall building infrastructure.

Furthermore, the factory-based production of cable bundles inherent to the palletized cable bundle system 1100 contributes to a reduction in material waste, as the controlled environment allows for precise measurement and allocation of wire and cable resources. This not only enhances the environmental sustainability of building projects but also leads to cost savings by minimizing the generation of leftover materials that could otherwise require proper disposal or recycling. In the case of complex and mission-critical projects, particularly those undertaken for high-security clients, the palletized cable bundle system 1100 provides the benefit of comprehensive cradle-to-grave documentation for all components, wires, and source materials incorporated into the finished bundle. This exhaustive record-keeping process meticulously tracks the country of origin and manufacturing dates for every element of the assembly, ensuring full traceability and compliance with stringent security and quality control standards. By leveraging the numerous advantages offered by the palletized cable bundle system 1100, building professionals can modify their approach to cable and conduit installation, achieving efficiency, reliability, and cost-effectiveness.

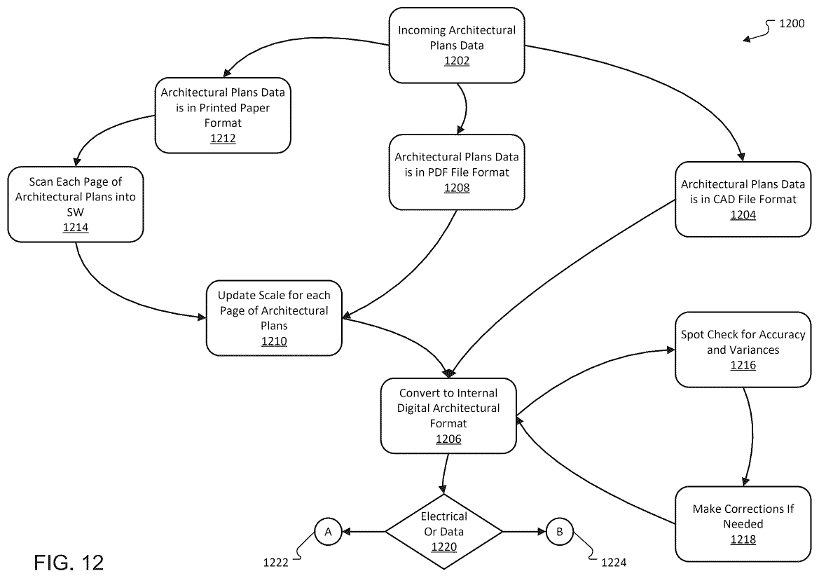

FIG. 12 illustrates a flow diagram of a method 1200 for generating electrical and cable assemblies for a building project, according to aspects of the present disclosure. The method 1200 begins with receiving incoming architectural plans data 1202, which may be provided in various formats, such as printed paper 1212, PDF 1208, or CAD file format 1204. Each format may require different handling to convert the architectural plans into a usable digital format. The receipt of these plans marks the first step in preparing for the creation of electrical and data infrastructure for a building project. Accurate handling of the incoming data ensures that all subsequent steps are based on reliable information. The architectural plans typically include detailed layouts and specifications that are used for precise planning and execution of the installation process.

When the architectural plans are received in PDF file format 1208, the next step can involve converting these files into a format that can be used by the internal digital architectural systems. This conversion step, depicted by the box 1208, ensures that the plans are in a digital format compatible with the software tools used for further processing. Specialized software may be used to convert PDF files into formats such as DWG or DXF, which are standard in the industry for CAD applications. This conversion facilitates precise manipulation and scaling of the plans to match the actual dimensions and specifications of the building project.

If the incoming architectural plans data is already in a CAD file format, such as DWG or DXF, represented by box 1204, the process can skip the PDF conversion step and proceed directly to using these files in the internal digital systems. CAD files are preferred because they are highly detailed and allow for precise modifications. They can be directly imported into the electrical or data CAD systems, reducing the need for additional conversion steps and potential errors. This direct import ensures that the most accurate and detailed version of the plans is used for further processing.

In box 1206, the plans, whether scanned from paper, converted from PDF, or directly received as CAD files, are converted into the internal digital architectural format. This standardized format is used for consistency and compatibility with various software tools used in the subsequent stages. The conversion process may involve scaling the plans to ensure they accurately reflect the real-world dimensions and specifications. This step ensures that all further calculations and designs are based on accurate and standardized data, facilitating a seamless workflow.

Following the conversion, each page of the architectural plans can be updated to the correct scale, as indicated in box 1210. This step ensures that all dimensions in the plans correspond accurately to the actual measurements in the physical space. Scaling updates are performed to maintain the integrity of the plans and to ensure that any annotations, dimensions, and details are accurately represented. This process often involves meticulous checks and adjustments to align the plans perfectly with the intended layout and design of the building project.

When the architectural plans are received in printed paper format 1212, the process can involve scanning each page into a digital format, as shown in box 1214. High-resolution scanners may be used to capture the details accurately, converting the physical documents into a digital format that can be manipulated and processed by the software systems. This step is used for integrating traditional paper-based plans into a modern digital workflow, ensuring that all data is accessible and editable in digital form.

The scanning step depicted in box 1214 ensures that printed architectural plans are digitized and ready for further processing. Each page is carefully scanned to capture all details, including annotations and dimensions. The resulting digital files are then processed to enhance readability and accuracy, preparing them for integration into the internal digital systems. This digitization transforms physical plans into a format that can be used for precise planning and execution in subsequent stages.

After scanning or converting the plans, a spot check for accuracy and variances is conducted, as shown in box 1216. This step involves verifying that the digital versions of the plans are accurate representations of the original documents. Any discrepancies or errors identified during this check are corrected to ensure that the plans are reliable and precise. This quality control measure can maintain the integrity of the data throughout the project lifecycle.

If any inaccuracies or variances are detected during the spot check, corrections are made as indicated in box 1218. This step ensures that all data used in subsequent processes is accurate and up-to-date. Corrections may involve adjusting dimensions, fixing scaling issues, or clarifying annotations. By addressing these issues early in the process, the risk of errors in later stages is minimized, ensuring a smooth and efficient workflow.

The process then diverges based on whether the project involves electrical or data infrastructure, as indicated in box 1220. This decision point directs the workflow towards the specific requirements and processes associated with either electrical or data cabling. Each path involves specialized steps and considerations tailored to the unique needs of electrical systems or data networks, ensuring that the infrastructure is designed and implemented correctly.

For data infrastructure, the next step involves calculating the paths and placement of data trays. This step involves detailed planning to determine the optimal routes for data cabling, ensuring efficient and organized distribution throughout the building. Factors such as cable lengths, tray capacities, and routing around obstacles are considered to create a comprehensive plan for data tray placement. This planning creates an efficient and scalable data network that meets the project's requirements.

For electrical infrastructure, the process involves calculating the best conduit runs. This step requires careful consideration of the building layout, electrical load requirements, and safety regulations. The goal is to design conduit runs that are efficient, cost-effective, and compliant with all relevant codes. These calculations ensure that the electrical infrastructure is robust, reliable, and capable of supporting the building's electrical needs. The detailed steps in FIG. 12 outline a comprehensive method for preparing architectural plans for the creation of electrical and data infrastructure, ensuring accuracy, efficiency, and reliability throughout the process.

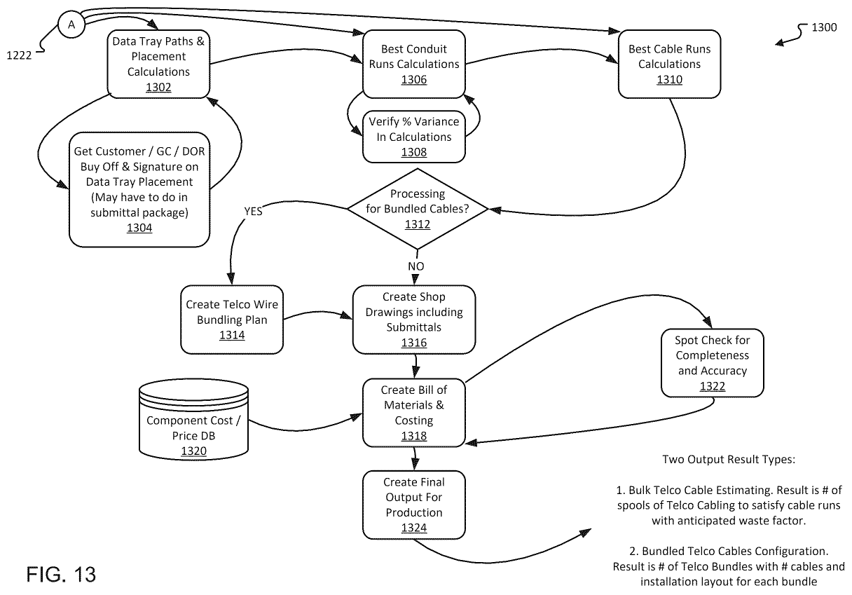

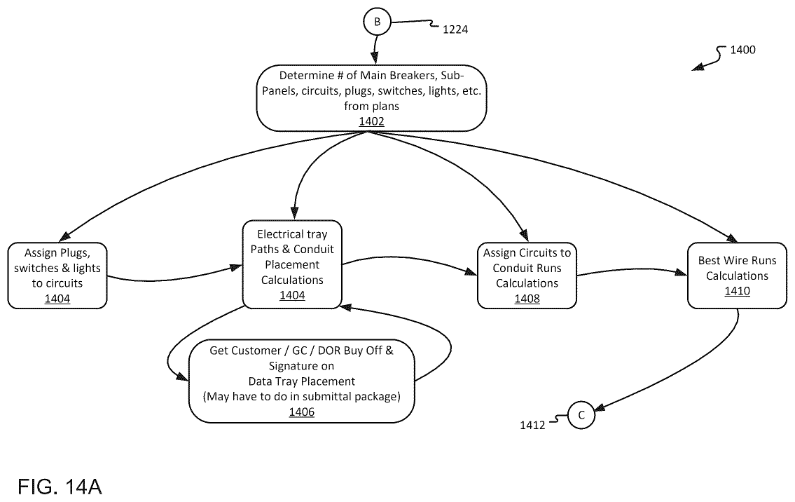

FIG. 13 illustrates a method 1300 for planning and preparing the installation of telecommunications infrastructure in a building project. This method encompasses several steps to ensure that data trays, conduits, and cable runs are optimally designed, approved, and documented before installation. The goal of this method is to create an efficient, reliable, and scalable telecommunications infrastructure that meets the project's specifications and complies with relevant standards and codes. The steps outlined below detail the comprehensive process involved in achieving this goal.

The process begins with calculating the paths and placements for data trays, as indicated in box 1302. This step involves determining the optimal routes for data cabling within the building's infrastructure. The selected paths aim to minimize the length of cable runs while avoiding physical obstacles and ensuring compliance with relevant building codes and standards. Placement calculations also consider the load capacity of the trays to prevent overloading and ensure structural integrity. These calculations can be performed using specialized software tools that model the building's layout and simulate the routing of cables.

Once the data tray paths and placements are calculated, the next step involves obtaining buy-in and approval from the customer, general contractor (GC), and the director of operations (DOR), as shown in box 1304. This approval process ensures that all stakeholders agree on the proposed layout and that any potential concerns are addressed before proceeding. The buy-off typically involves reviewing detailed drawings and plans and obtaining signatures to formally approve the placement of data trays. This step ensures alignment and avoids costly changes later in the project.

Following the approval of data tray placements, the best conduit runs are calculated as depicted in box 1306. This step involves identifying the most efficient and practical routes for telecommunications conduits. The calculations consider factors such as the distance between network hubs and endpoints, the number of bends in the conduit runs, and the capacity requirements for the cables they will house. Software tools can be used to simulate the conduit runs and optimize their paths to ensure compliance with telecommunications standards while aiming to reduce material and labor costs.

The next step is to verify the percentage variance in the calculations, as indicated in box 1308. This involves checking the accuracy of the initial calculations for data tray paths, placements, and conduit runs. The variance check ensures that the planned routes and placements align with the actual building dimensions and specifications. Any discrepancies are addressed by adjusting the calculations to ensure precision and reliability. This verification step helps to prevent issues during installation and ensures that the plans are executable in the real-world setting.

After verifying the conduit runs, the best cable runs are calculated, as shown in box 1310. This step involves determining the optimal routing for telecommunications cables within the conduits and trays. The calculations consider the type and number of cables, their lengths, and the required bend radii to prevent damage and maintain signal integrity. The goal is to ensure efficient cable management, minimize crosstalk and interference, and comply with installation standards. These calculations also help in planning the installation process, ensuring that cables are laid out in a manner that facilitates easy access and maintenance.

Once the cable runs are determined, the next step is processing for bundled cables, as depicted in box 1312. This involves organizing cables into bundles based on their destinations and functions. Bundling cables can simplify the installation process, reduce clutter, and improve airflow within conduits and trays. The bundles are designed to meet specific performance criteria, such as minimizing electromagnetic interference (EMI) and maintaining proper spacing between cables. This step may also include labeling each bundle for easy identification during installation and future maintenance.

The creation of a telecommunications (Telco) wire bundling plan is the next step, as shown in box 1314. This plan outlines how telecommunications cables will be grouped and routed through the building. The bundling plan takes into account the types of cables (e.g., Ethernet, fiber optic), their destinations, and any specific requirements for spacing and protection. A goal is to create an efficient and organized layout that facilitates easy installation and future upgrades. The bundling plan also includes labeling and documentation to ensure that the installation team can accurately follow the plan.

Creating shop drawings, including submittals, is depicted in box 1316. These detailed drawings provide a visual representation of the installation plan, including the layout of data trays, conduits, and cable bundles. Shop drawings are used to communicate the design to the installation team and other stakeholders. Submittals include detailed specifications and product data for the materials and components to be used. These documents are reviewed and approved by the customer and other stakeholders to ensure that the installation meets all requirements and standards.

The creation of a bill of materials (BOM) and costing is the next step, as shown in box 1318. The BOM lists all the materials and components required for the installation, including quantities, specifications, and part numbers. Costing involves calculating the total cost of the materials and labor required for the installation. This step ensures that all necessary materials are accounted for and that the project stays within budget. The BOM and costing also help in procurement and project planning.

Maintaining a component cost/price database is indicated in box 1320. This database includes up-to-date pricing information for all materials and components used in the installation. It serves as a reference for creating accurate cost estimates and budgets. The database is regularly updated to reflect changes in market prices and supplier costs. This step helps ensure that the project remains financially viable and that cost estimates are accurate.

A spot check for completeness and accuracy is conducted next, as shown in box 1322. This involves reviewing all plans, drawings, and calculations to ensure they are complete and accurate. The spot check identifies any discrepancies or missing information that need to be addressed before proceeding with the installation. This step helps to prevent issues during installation and ensures that all aspects of the project are thoroughly planned and documented.

A final step is creating the output for production, as depicted in box 1324. This involves compiling all plans, drawings, and documentation into a final package that is used by the production and installation teams. The output includes detailed instructions for installing data trays, conduits, and cable bundles, as well as any special instructions or considerations. The final output ensures that the installation team has all the information they need to complete the project efficiently and accurately. This step marks the transition from the planning phase to the execution phase of the project. The output can be divided into two result types: Bulk Telco Cable Estimating: The result is the number of spools of Telco Cabling required to satisfy cable runs, including an anticipated waste factor. Bundled Telco Cables Configuration: The result is the number of Telco Bundles with the specified number of cables and the installation layout for each bundle.

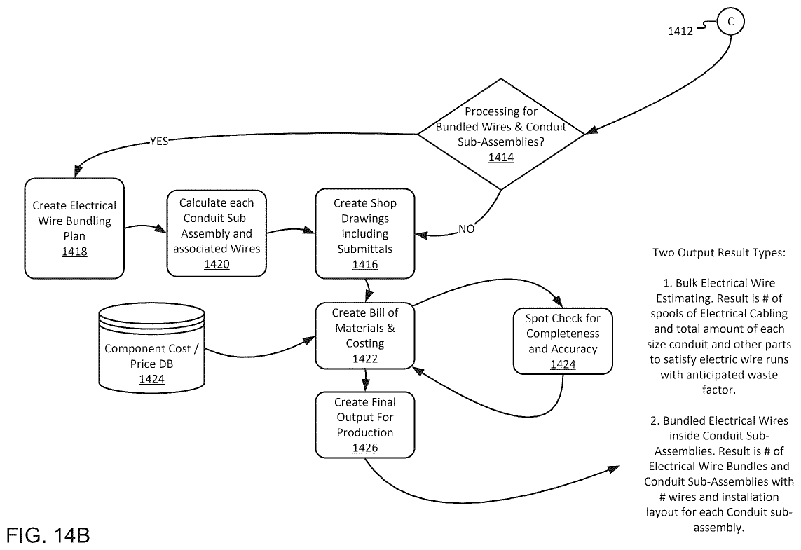

FIGS. 14A and 14B illustrate a method 1400 for planning and preparing the installation of electrical infrastructure in a building project. This method includes several steps to ensure that electrical trays, conduits, and wire runs are optimally designed, approved, and documented before installation begins. A goal of this method is to create an efficient, reliable, and scalable electrical infrastructure that meets the project's specifications and complies with relevant standards and codes. The steps outlined below detail the comprehensive process involved in achieving this goal.

As depicted in FIG. 14A, the process begins with determining the number of main breakers, sub-panels, circuits, plugs, switches, lights, and other electrical components required for the project, as indicated in box 1402. This step involves a detailed analysis of the architectural plans to identify the electrical needs of the building. Factors considered include the building's size, layout, and intended use. This information is used to develop a comprehensive list of electrical components, which serves as the basis for subsequent calculations and designs.

Once the necessary electrical components are identified, the next step involves assigning plugs, switches, and lights to specific circuits, as shown in box 1404. This step ensures that the electrical load is evenly distributed across the circuits, preventing overloads and ensuring reliable operation. The assignment is based on factors such as the location of the components, the anticipated electrical load, and safety regulations. This step is crucial for designing an efficient and safe electrical system.

After assigning components to circuits, the next step involves obtaining buy-in and approval from the customer, general contractor (GC), and the director of operations (DOR) on the placement of data trays and other key elements, as shown in box 1406. This approval process ensures that all stakeholders agree on the proposed layout and that any potential concerns are addressed before proceeding. The buy-off typically involves reviewing detailed drawings and plans and obtaining signatures to formally approve the placement. This step ensures alignment and avoids costly changes later in the project.

Following the approval of data tray placements, the assignment of circuits to conduit runs is calculated as depicted in box 1408. This step involves identifying the most efficient and practical routes for electrical conduits that will house the assigned circuits. The calculations consider factors such as the distance between electrical panels and endpoints, the number of bends in the conduit runs, and the capacity requirements for the cables they will house. Software tools can be used to simulate the conduit runs and optimize their paths to ensure compliance with electrical codes and standards, while also aiming to reduce material and labor costs.

After assigning circuits to conduit runs, the best wire runs are calculated, as shown in box 1410. This step involves determining the optimal routing for electrical wires within the conduits. The calculations consider the type and number of wires, their lengths, and the required bend radii to prevent damage and maintain signal integrity. A goal is to ensure efficient wire management, minimize crosstalk and interference, and comply with installation standards. These calculations also help in planning the installation process, ensuring that wires are laid out in a manner that facilitates easy access and maintenance.

As depicted in FIG. 14B, once the wire runs are determined, the next step is creating an electrical wire bundling plan, as depicted in box 1412. This plan outlines how electrical wires will be grouped and routed through the building. The bundling plan takes into account the types of wires, their destinations, and any specific requirements for spacing and protection. The goal is to create an efficient and organized layout that facilitates easy installation and future upgrades. The bundling plan also includes labeling and documentation to ensure that the installation team can accurately follow the plan.

The next step involves processing for bundled wires and conduit sub-assemblies, as shown in box 1414. This involves organizing wires into bundles based on their destinations and functions, and then integrating these bundles into conduit sub-assemblies. Bundling wires can simplify the installation process, reduce clutter, and improve airflow within conduits and trays. The bundles are designed to meet specific performance criteria, such as minimizing electromagnetic interference (EMI) and maintaining proper spacing between wires. This step may also include labeling each bundle for easy identification during installation and future maintenance.

Creating shop drawings, including submittals, is depicted in box 1416. These detailed drawings provide a visual representation of the installation plan, including the layout of data trays, conduits, and wire bundles. Shop drawings are used to communicate the design to the installation team and other stakeholders. Submittals include detailed specifications and product data for the materials and components to be used. These documents are reviewed and approved by the customer and other stakeholders to ensure that the installation meets all requirements and standards.

In accordance with examples of the present disclosure, box 1418 involves creating an electrical wire bundling plan. This step entails determining the optimal arrangement and configuration of electrical wires into bundles. The plan includes selecting the appropriate types of wires, their lengths, and the specific routes they will take within the conduits and trays. The bundling plan ensures that the electrical system is organized, reducing clutter and making future maintenance easier. It also helps in identifying potential issues related to wire capacity and spacing, ensuring compliance with safety standards.

The next step involves calculating each conduit sub-assembly and the associated wires, as shown in box 1420. This calculation ensures that each conduit sub-assembly is correctly sized and configured to house the assigned wire bundles. Factors considered include the conduit diameter, the number of wires, and the required bend radii. These calculations ensure that the conduit sub-assemblies are efficient and comply with relevant standards.

The creation of a bill of materials (BOM) and costing is the next step, as shown in box 1422. The BOM lists all the materials and components required for the installation, including quantities, specifications, and part numbers. Costing involves calculating the total cost of the materials and labor required for the installation. This step ensures that all necessary materials are accounted for and that the project stays within budget. The BOM and costing also help in procurement and project planning.

Maintaining a component cost/price database is indicated in box 1424. This database includes up-to-date pricing information for all materials and components used in the installation. It serves as a reference for creating accurate cost estimates and budgets. The database is regularly updated to reflect changes in market prices and supplier costs. This step helps ensure that the project remains financially viable and that cost estimates are accurate.

The final step is creating the output for production, as depicted in box 1426. This involves compiling all plans, drawings, and documentation into a final package that is used by the production and installation teams. The output includes detailed instructions for installing data trays, conduits, and wire bundles, as well as any special instructions or considerations. The final output ensures that the installation team has all the information they need to complete the project efficiently and accurately. This step marks the transition from the planning phase to the execution phase of the project.

FIGS. 14A and 14B illustrate a comprehensive method for planning and preparing the installation of electrical infrastructure in a building project. The method involves calculating optimal paths and placements for data trays and conduits, obtaining stakeholder approval, verifying calculations, processing for bundled wires and conduit sub-assemblies, creating detailed plans and documentation, and preparing the final output for production. Each step is designed to ensure accuracy, efficiency, and compliance with relevant standards, resulting in a well-organized and reliable installation.

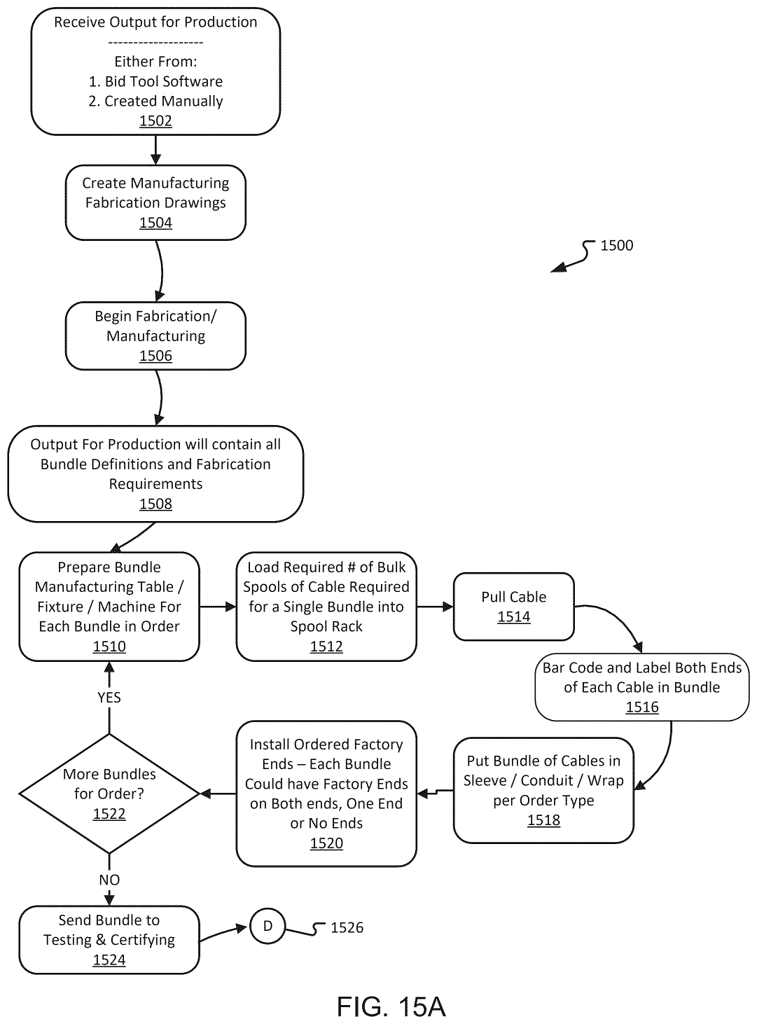

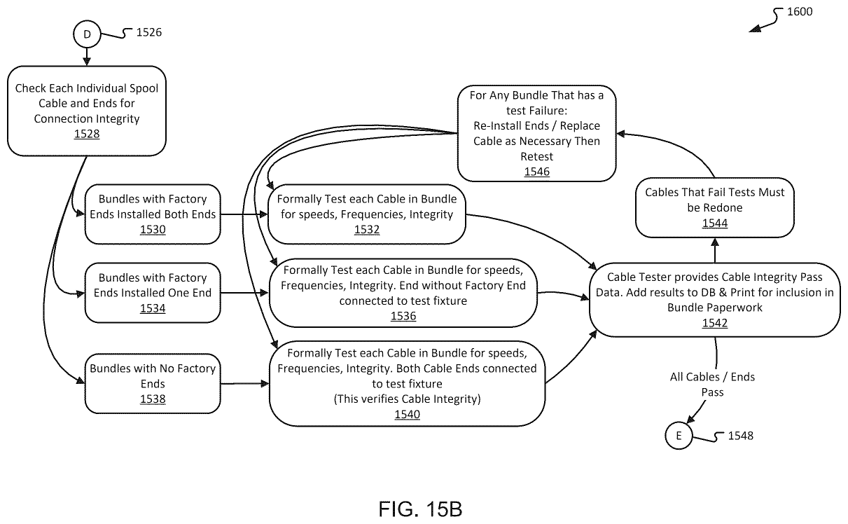

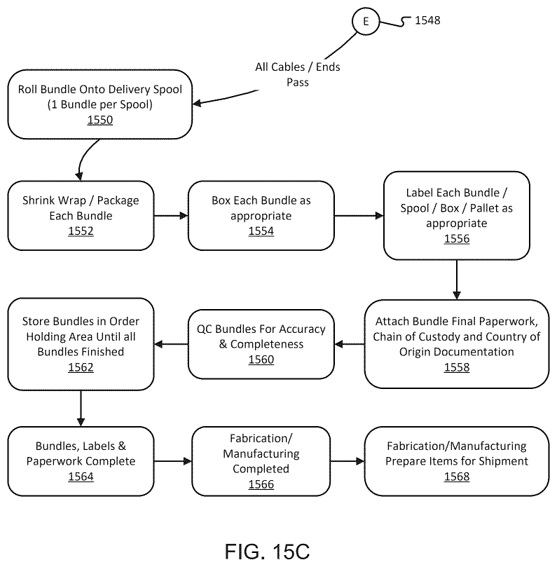

FIGS. 15A, 15B, and 15C illustrate a method 1500 for the fabrication and testing of cable bundles for telecommunications and electrical infrastructure. This method encompasses several steps to ensure that the cable bundles are accurately prepared, tested, and packaged for deployment. The goal of this method is to create efficient, reliable, and scalable cable bundles that meet the project's specifications and comply with relevant standards and codes. The steps outlined below detail the comprehensive process involved in achieving this goal.

The process begins with receiving the output for production, as indicated in box 1502. This output can be generated from either bid tool software or created manually. The output includes all necessary specifications and requirements for the cable bundles to be produced. This step serves as the foundation for the subsequent fabrication and manufacturing processes. Once the output is received, the next step involves creating manufacturing fabrication drawings, as shown in box 1504. These detailed drawings provide a visual representation of the cable bundles, including the layout, dimensions, and specific components required. The drawings guide the production team in assembling the cable bundles according to the project specifications.

With the fabrication drawings prepared, the process proceeds to the fabrication and manufacturing phase, as depicted in box 1506. This step involves setting up the manufacturing environment, including preparing the necessary tools, equipment, and materials. The production team begins assembling the cable bundles based on the provided drawings and specifications. As part of the fabrication process, the output for production will contain bundle definitions and fabrication requirements, as indicated in box 1508. This comprehensive documentation ensures that the production team has all the necessary information to produce the cable bundles accurately. It includes detailed instructions, material lists, and quality control measures.

The next step involves preparing the bundle manufacturing table, fixture, or machine for each bundle in the order, as shown in box 1510. This preparation ensures that the production environment is optimized for the specific requirements of each bundle. It includes configuring the equipment, setting up fixtures, and organizing materials for efficient production. Once the manufacturing setup is complete, the required number of bulk spools of cable for a single bundle is loaded into the spool rack, as depicted in box 1512. This step ensures that the necessary materials are readily available for the production process. The spools are organized and positioned to facilitate smooth and efficient cable handling.

The process continues with pulling the cable from the spools, as shown in box 1514. This step involves measuring and cutting the cables to the required lengths for each bundle. The cables are then organized and prepared for assembly, ensuring they are free from tangles and damage. After the cables are cut and organized, both ends of each cable in the bundle are barcoded and labeled, as indicated in box 1516. This labeling process facilitates easy identification and tracking of the cables throughout the production and installation processes. Barcoding also aids in inventory management and quality control.

The next step involves placing the bundle of cables in the appropriate sleeve, conduit, or wrap per the order type, as shown in box 1518. This step ensures that the cables are protected and organized according to the project specifications. The type of enclosure used depends on the specific requirements of the installation environment. Following the wrapping process, the ordered factory ends are installed on each bundle, as indicated in box 1520. Each bundle could have factory ends installed on both ends, one end, or no ends, depending on the project requirements. This step involves attaching the appropriate connectors or terminations to the cables, ensuring they are ready for installation.

At this point, the process checks if there are more bundles to be produced for the order, as shown in box 1522. If more bundles are needed, the process returns to the relevant steps to produce the additional bundles. If no more bundles are required, the process proceeds to the next phase. Once all bundles for the order are produced, they are sent to the testing and certifying stage, as indicated in box 1524. This step involves verifying the quality and integrity of the cable bundles through various tests, ensuring they meet the project specifications and standards.

The testing phase begins with checking each individual spool cable and its ends for connection integrity, as shown in box 1526. This step involves inspecting the connections to ensure they are secure and free from defects. Proper connection integrity is essential for the reliable performance of the cable bundles. The process then focuses on bundles with factory ends installed on both ends, as indicated in box 1528. These bundles are subjected to specific tests to verify their performance and integrity. The testing ensures that the factory-installed ends meet the required standards and are properly connected. Each cable in the bundle is formally tested for speeds, frequencies, and integrity, as shown in box 1530. This testing involves using specialized equipment to measure the performance of the cables, ensuring they meet the required specifications for data transmission and signal quality.

The cable tester provides cable integrity pass data, which is then added to the database and printed for inclusion in the bundle paperwork, as indicated in box 1532. This documentation serves as a record of the test results, ensuring that each bundle meets the required standards and can be verified for quality control purposes. The process then focuses on bundles with factory ends installed on one end, as shown in box 1534. These bundles are tested to ensure that the single factory end is properly connected and meets the required standards. The testing process is similar to that for bundles with ends installed on both ends. Each cable in the bundle is formally tested for speeds, frequencies, and integrity, with the end without the factory end connected to a test fixture, as indicated in box 1536. This testing ensures that the entire length of the cable meets the required performance standards.

Finally, the process focuses on bundles with no factory ends, as shown in box 1538. These bundles are tested to ensure that the cables meet the required specifications throughout their length. The testing process involves connecting the cables to test fixtures and verifying their performance. Each cable in the bundle is formally tested for speeds, frequencies, and integrity, with both cable ends connected to a test fixture, as indicated in box 1540. This testing verifies that the cable maintains its performance and integrity throughout its entire length. If any cables fail the tests, they must be redone, as shown in box 1542. This step involves identifying and correcting any issues with the cables, ensuring that all cables meet the required standards before proceeding.

If any cables fail the tests, they must be redone, as shown in box 1542. This step involves identifying and correcting any issues with the cables. This may include re-terminating the ends, replacing damaged sections, or reassembling the cable bundle. Ensuring that all cables meet the required standards before proceeding helps maintain the integrity and reliability of the final product. For any bundle that has a test failure, the ends are re-installed or the cable is replaced as necessary, and then the bundle is retested, as indicated in box 1544. This step ensures that any detected issues are fully resolved and that the bundles meet all required performance and quality standards. Retesting verifies that the corrective actions have been successful and that the bundles are ready for deployment.

The process then moves to the final stages of fabrication and manufacturing, as shown in box 1546. For any bundle that has a test failure, the ends are re-installed, or the cable is replaced as necessary, and then retested. This step involves completing any remaining fabrication tasks to ensure that the bundles are fully assembled and meet all specified requirements. Final inspections and quality checks are performed to confirm that the bundles are ready for the next phase. Once fabrication is complete, the items are prepared for shipment, as indicated in box 1548. This preparation involves organizing and packaging the bundles to ensure they are protected during transport. All necessary shipping materials and documentation are gathered and included.

The next step involves rolling each bundle onto a delivery spool, with one bundle per spool, as shown in box 1550. This method of packaging facilitates easy handling and installation at the destination. The spools help protect the cables from damage during transport and storage. Each bundle is then shrink-wrapped or otherwise packaged, as indicated in box 1552. This protective packaging helps prevent damage from moisture, dust, and other environmental factors during transport. Shrink-wrapping also keeps the bundles neatly organized. The packaged bundles are then placed in boxes, as shown in box 1554. The boxes are selected based on the size and requirements of the bundles to ensure they are securely packed for transport. Proper boxing further protects the bundles from damage and makes handling easier.

Each bundle, spool, box, and pallet is labeled appropriately, as indicated in box 1556. The labeling includes relevant information such as the contents, destination, handling instructions, and any other necessary identifiers. This facilitates easy identification and tracking throughout the shipping process. The final paperwork, chain of custody, and country of origin documentation are attached to each bundle, as shown in box 1558. This documentation ensures that all necessary information is included for regulatory compliance, quality assurance, and traceability. Proper documentation supports seamless customs clearance and adherence to legal requirements.

A quality control (QC) check is performed on the bundles for accuracy and completeness, as indicated in box 1560. This step involves a thorough review to ensure that all bundles are correctly assembled, labeled, and documented before shipment. The QC check helps prevent any issues during transport and installation. The completed bundles are stored in an order holding area until all bundles for the order are finished, as shown in box 1562. This step ensures that all bundles are ready for shipment together, facilitating efficient logistics and delivery. Bundles are kept in a secure location to maintain their condition.

Once all bundles, labels, and paperwork are complete, as indicated in box 1564, the bundles are ready for shipment. This step confirms that all required tasks have been completed and that the bundles are prepared for delivery. Final checks are performed to ensure that nothing is overlooked. The fabrication and manufacturing process is completed, as shown in box 1566. This step marks the end of the production phase, transitioning to the shipping and installation phases of the project. All production activities are concluded, and the focus shifts to logistics.

The final step involves preparing the items for shipment, as indicated in box 1568. This step ensures that all bundles are securely packed, labeled, and documented, ready for transport to the installation site.

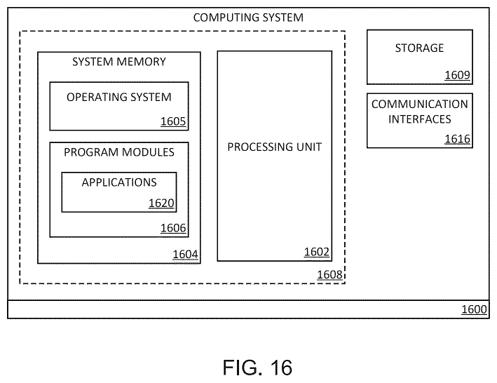

FIG. 16 illustrates a computing system 1600 that can be utilized to execute various methods described in this disclosure, such as those related to planning, fabricating, and testing cable bundles for telecommunications and electrical infrastructure. The computing system 1600 includes several components that work together to process data, execute instructions, and communicate with other systems and devices.

The processing unit 1602 is the central component of the computing system 1600. It can be a microprocessor, microcontroller, or other processing device capable of executing instructions stored in the system memory 1604. The processing unit 1602 performs the computations and logical operations necessary to carry out the methods described herein, such as calculating cable lengths, verifying design specifications, and managing manufacturing processes. The processing unit 1602 can include multiple cores or processors to enhance performance and enable parallel processing of tasks.

The system memory 1604 comprises various types of memory used to store data and instructions that the processing unit 1602 needs to execute tasks. This includes both volatile memory (e.g., RAM) and non-volatile memory (e.g., ROM or flash memory). The system memory 1604 contains the operating system 1605, which manages hardware resources and provides services for application software, and program modules 1606, which include applications 1620 that perform specific functions related to the cable bundle planning, fabrication, and testing processes.

The operating system 1605 is a software component stored in the system memory 1604 that manages hardware resources and provides services to application software. It facilitates communication between the processing unit 1602 and other hardware components, ensuring efficient execution of tasks. The program modules 1606 are software components stored in the system memory 1604 that perform specific functions related to the overall operations of the computing system 1600. These modules include applications 1620, which can be specialized software tools for designing cable layouts, generating manufacturing fabrication drawings, and managing the testing and certification of cable bundles.

The system bus 1608 is a communication pathway that facilitates data transfer between the various components of the computing system 1600. It connects the processing unit 1602, system memory 1604, and other peripheral devices, ensuring that data can be efficiently exchanged and processed. The storage 1609 is a non-volatile memory component that provides long-term data storage. It can include hard drives, solid-state drives, or other storage media. This storage is used to save detailed manufacturing drawings, test results, documentation, and other data that needs to be retained beyond the current processing session.

The communication interfaces 1616 are components that enable the computing system 1600 to communicate with external devices and systems. These interfaces can include network adapters, wireless communication modules, and other connectivity devices. They facilitate the exchange of data between the computing system 1600 and other systems involved in the cable fabrication and testing processes, such as external databases, remote servers, and networked manufacturing equipment. The applications 1620 are specific software programs that reside within the program modules 1606. These applications can include tools for planning cable runs, calculating optimal conduit paths, generating fabrication drawings, and managing the testing and certification of cable bundles. The applications leverage the processing power of the processing unit 1602 and the data stored in the system memory 1604 and storage 1609 to perform their designated tasks.

The computing system 1600 provides a robust and flexible platform for executing the methods described in this disclosure, ensuring that cable bundles are designed, fabricated, tested, and documented in an efficient and accurate manner. The integration of various hardware and software components enables seamless operation and coordination of complex processes involved in telecommunications and electrical infrastructure projects.

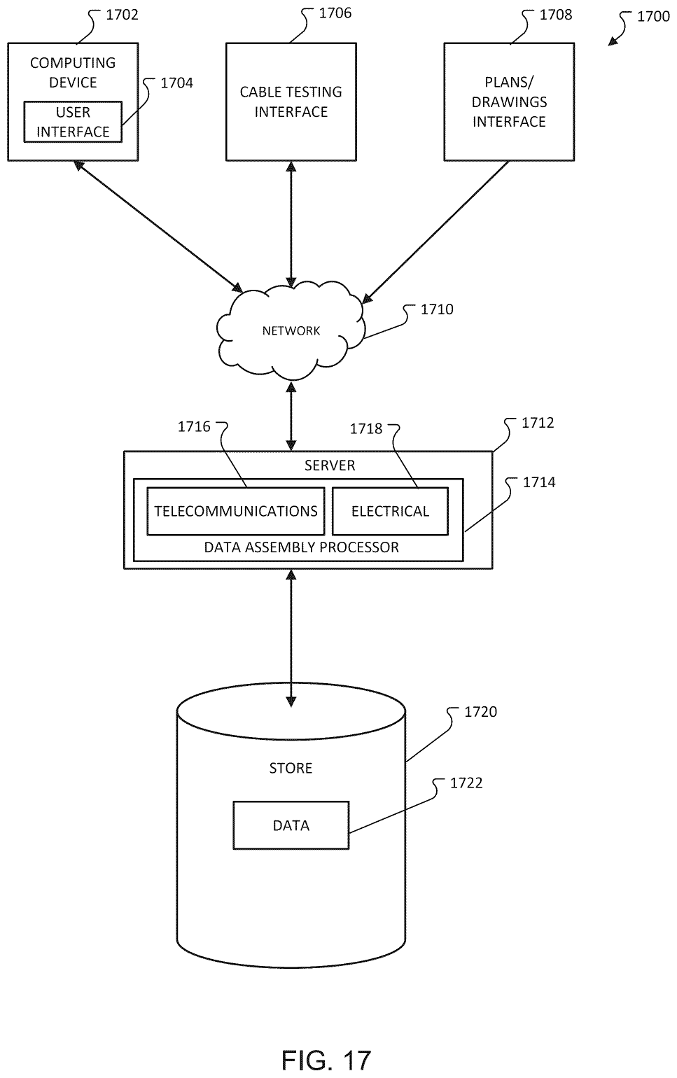

FIG. 17 illustrates a networked computing environment 1700 used for planning, fabricating, and testing cable bundles for telecommunications and electrical infrastructure. The environment includes multiple interconnected components that work together to process data, execute instructions, and communicate with other systems and devices.

The computing device 1702 includes a user interface 1704. This device can be a desktop computer, laptop, tablet, or any other device that allows users to interact with the system. The user interface 1704 facilitates the input and output of data, enabling users to manage cable bundle planning, fabrication, and testing processes. Through the user interface, users can access various software applications and tools needed to execute these tasks.

The cable testing interface 1703 connects to the computing device and allows for the testing of cable bundles. This interface is responsible for running tests to verify the integrity, performance, and compliance of the cables. It communicates the test results back to the computing device and stores relevant data for further analysis and reporting.

The plans/drawings interface 1708 provides access to detailed plans and drawings necessary for the fabrication and installation of cable bundles. This interface allows users to view, edit, and manage technical drawings and blueprints, ensuring that all design specifications are met accurately. The interface plays a crucial role in translating design requirements into actionable manufacturing instructions.

The network 1710 connects the various components within the computing environment 1700, facilitating data exchange and communication between devices. This network can be a local area network (LAN), wide area network (WAN), or the internet. It ensures that data flows seamlessly between the computing device, cable testing interface, plans/drawings interface, and other connected systems.

The server 1712 hosts several critical functions and processes required for managing telecommunications and electrical infrastructure projects. It includes: The data assembly processor 1714 is a component within the server that processes and integrates data from various sources. It assembles and organizes data related to cable bundle planning, fabrication, and testing, ensuring that all information is accurately compiled and ready for analysis. The telecommunications module 1716 manages all data and processes related to telecommunications infrastructure. This module handles the specific requirements for planning, fabricating, and testing telecommunications cable bundles, ensuring that they meet the necessary standards and specifications.

The electrical module 1718 manages all data and processes related to electrical infrastructure. Similar to the telecommunications module, it ensures that the electrical cable bundles are planned, fabricated, and tested according to project requirements and industry standards.

The storage 1720 is a component that provides long-term data storage for the computing environment 1700. It can include hard drives, solid-state drives, or other storage media. The storage is used to save detailed manufacturing drawings, test results, documentation, and other data that needs to be retained beyond the current processing session. The data 1722 stored within the storage 1720 includes all relevant information needed for the planning, fabrication, and testing of cable bundles. This data may include test results, design specifications, project documentation, and any other critical information that supports the overall process.

The networked computing environment 1700, as illustrated in FIG. 17, provides a robust and flexible platform for executing the methods described in this disclosure. It ensures that cable bundles are designed, fabricated, tested, and documented efficiently and accurately. The integration of various hardware and software components enables seamless operation and coordination of complex processes involved in telecommunications and electrical infrastructure projects.

### EXAMPLE CLAUSES

Implementation examples are described in the following numbered clauses:

Clause 1: A modular conduit assembly, comprising: a plurality of straight conduit segments; one or more corner conduit segments, each comprising a bend of a predetermined angle; and a plurality of joint connectors configured to interconnect the straight conduit segments and the one or more corner conduit segments to form an enclosed pathway for routing one or more cables or wires.

Clause 2: The modular conduit assembly of Clause 1, wherein the joint connectors are configured to interconnect the straight conduit segments and the one or more corner conduit segments by one or more connection methods selected from the group consisting of: rotation, insertion, crimping, bolting, snap locking, gluing, quick disconnecting, threading, and sleeve connecting.

Clause 3: The modular conduit assembly according to any one of Clauses 1-2, wherein the straight conduit segments and the one or more corner conduit segments comprise one or more conduit types selected from the group consisting of: liquid tight conduit, steel flexible conduit, and other flexible conduit with appropriate end connectors.

Clause 4: The modular conduit assembly according to any one of Clauses 1-3, wherein the enclosed pathway formed by the interconnected straight conduit segments and one or more corner conduit segments is configured to prevent ingress of contaminants.

Clause 5: The modular conduit assembly according to any one of Clauses 1-4, wherein the assembly is configured to be arranged in a packaged configuration and an unpackaged configuration, wherein in the packaged configuration the straight conduit segments and the one or more corner conduit segments are arranged to form a compact bundle, and wherein in the unpackaged configuration the straight conduit segments and the one or more corner conduit segments are interconnected to form an extended conduit run.

Clause 6: The modular conduit assembly of Clause 5, wherein the assembly is configured to transition from the packaged configuration to the unpackaged configuration by unfolding the compact bundle.

Clause 7: The modular conduit assembly of Clause 6, wherein the assembly comprises a swiveling connector configured to enable the unfolding of the compact bundle, the swiveling connector comprising a plurality of sub-sections each having a predetermined bend angle.

Clause 8: The modular conduit assembly of Clause 7, wherein each of the plurality of sub-sections of the swiveling connector has a bend angle of 22.5 degrees.

Clause 9: The modular conduit assembly according to any one of Clauses 5-8, wherein in the packaged configuration, ends of the one or more cables or wires are exposed, and wherein the joint connectors are configured to connect the exposed ends of the one or more cables or wires after the assembly is transitioned to the unpackaged configuration.

Clause 10: The modular conduit assembly of Clause 9, wherein the joint connectors comprise slide-on sleeve connectors configured to slidably engage the straight conduit segments to form a connection.

Clause 11: The modular conduit assembly according to any one of Clauses 1-10, wherein the assembly is configured to be shipped as a pre-assembled unit with the one or more cables or wires pre-installed in the enclosed pathway.

Clause 12: The modular conduit assembly of Clause 11, wherein the pre-assembled unit is configured to be unfolded at an installation site to form an extended conduit run with the one or more cables or wires already installed.

Clause 13: The modular conduit assembly according to any one of Clauses 1-12, wherein the corner conduit segments are configured to enable the enclosed pathway to change directions while maintaining a minimum bend radius of the one or more cables or wires.

Clause 14: The modular conduit assembly according to any one of Clauses 1-13, further comprising a snap-on cover configured to enclose and protect a portion of the one or more cables or wires routed through the straight conduit segments.

Clause 15: The modular conduit assembly of Clause 14, wherein the snap-on cover comprises two half-pieces configured to engage each other to form a full enclosure around the portion of the one or more cables or wires.

Clause 16: The modular conduit assembly according to any one of Clauses 14-15, wherein the snap-on cover is configured to provide one or more functions selected from the group consisting of: repair of the enclosed pathway, and interconnection of the straight conduit segments.

Clause 17: A corner conduit assembly, comprising: a first conduit segment having a first end and a second end; a second conduit segment having a first end and a second end; and a swiveling connector interconnecting the second end of the first conduit segment to the first end of the second conduit segment, the swiveling connector configured to allow the first conduit segment and the second conduit segment to rotate relative to each other while maintaining an enclosed pathway through the first conduit segment, the swiveling connector, and the second conduit segment.

Clause 18: The corner conduit assembly of Clause 17, wherein the swiveling connector comprises: a first coupling element connected to the second end of the first conduit segment; and a second coupling element connected to the first end of the second conduit segment, wherein the first coupling element and the second coupling element are configured to rotatably engage each other.

Clause 19: The corner conduit assembly of Clause 18, wherein the first coupling element comprises a male coupling portion and the second coupling element comprises a female coupling portion, wherein the male coupling portion is configured to be inserted into the female coupling portion to form a rotatable connection.

Clause 20: The corner conduit assembly of Clause 19, wherein the male coupling portion comprises a first cylindrical body and the female coupling portion comprises a second cylindrical body configured to receive the first cylindrical body.

Clause 21: The corner conduit assembly according to any one of Clauses 18-20, wherein the swiveling connector further comprises one or more sealing elements disposed between the first cylindrical body and the second cylindrical body to form a sealed connection.

Clause 22: The corner conduit assembly of Clause 21, wherein the one or more sealing elements comprise one or more O-rings.

Clause 23: The corner conduit assembly according to any one of Clauses 18-22, wherein the swiveling connector further comprises one or more bearing elements disposed between the first cylindrical body and the second cylindrical body to enable smooth rotation.

Clause 24: The corner conduit assembly according to any one of Clauses 17-23, wherein the swiveling connector is configured to allow the first conduit segment and the second conduit segment to swivel between an aligned configuration and an angled configuration.

Clause 25: The corner conduit assembly of Clause 24, wherein in the aligned configuration, a longitudinal axis of the first conduit segment is substantially aligned with a longitudinal axis of the second conduit segment.

Clause 26: The corner conduit assembly of Clause 24, wherein in the angled configuration, the longitudinal axis of the first conduit segment is at an angle relative to the longitudinal axis of the second conduit segment.

Clause 27: The corner conduit assembly of Clause 26, wherein the angle between the longitudinal axis of the first conduit segment and the longitudinal axis of the second conduit segment in the angled configuration is in the range of 0 degrees to 180 degrees.

Clause 28: The corner conduit assembly according to any one of Clauses 17-27, wherein the swiveling connector comprises a plurality of interlocking sections configured to enable relative rotation between the first conduit segment and the second conduit segment.

Clause 29: The corner conduit assembly of Clause 28, wherein each of the plurality of interlocking sections comprises a predetermined bend angle.

Clause 30: The corner conduit assembly of Clause 29, wherein the predetermined bend angle of each of the plurality of interlocking sections is 22.5 degrees.

Clause 31: The corner conduit assembly according to any one of Clauses 17-30, wherein the swiveling connector is configured to enable the first conduit segment and the second conduit segment to transition between a packaged configuration and an unpackaged configuration.

Clause 32: The corner conduit assembly of Clause 31, wherein in the packaged configuration, the first conduit segment and the second conduit segment are oriented substantially parallel to each other, and wherein in the unpackaged configuration, the first conduit segment and the second conduit segment are oriented at an angle relative to each other.

Clause 33: A conduit connector assembly comprising: a first conduit segment having a first end and a second end; a second conduit segment having a first end and a second end; a male coupling portion disposed at the second end of the first conduit segment, the male coupling portion comprising a first cylindrical body; a female coupling portion disposed at the first end of the second conduit segment, the female coupling portion comprising a second cylindrical body configured to receive the first cylindrical body; and one or more sealing elements disposed between the first cylindrical body and the second cylindrical body, the one or more sealing elements configured to form a sealed connection between the first conduit segment and the second conduit segment.

Clause 34: The conduit connector assembly of Clause 33, wherein the one or more sealing elements comprise one or more O-rings.

Clause 35: The conduit connector assembly of Clause 34, wherein the male coupling portion further comprises one or more grooves configured to seat the one or more O-rings.

Clause 36: The conduit connector assembly of Clause 35, wherein the one or more grooves are machined into an outer surface of the first cylindrical body.

Clause 37: The conduit connector assembly of Clause 34, wherein the female coupling portion further comprises one or more grooves configured to seat the one or more O-rings.

Clause 38: The conduit connector assembly of Clause 37, wherein the one or more grooves are machined into an inner surface of the second cylindrical body.

Clause 39: The conduit connector assembly according to any one of Clauses 33-38, wherein the sealed connection is configured to prevent ingress of moisture, dirt, or other contaminants into an interior of the conduit connector assembly.

Clause 40: The conduit connector assembly according to any one of Clauses 33-39, wherein the male coupling portion and the female coupling portion are configured to enable relative rotation between the first conduit segment and the second conduit segment while maintaining the sealed connection.

Clause 41: The conduit connector assembly of Clause 40, wherein the male coupling portion and the female coupling portion form a swivel joint.

Clause 42: The conduit connector assembly according to any one of Clauses 33-41, further comprising one or more bearing elements disposed between the first cylindrical body and the second cylindrical body, the one or more bearing elements configured to enable smooth rotation between the first conduit segment and the second conduit segment.

Clause 43: The conduit connector assembly according to any one of Clauses 33-42, wherein the first conduit segment and the second conduit segment comprise one or more materials selected from the group consisting of metal, plastic, and composite.

Clause 44: The conduit connector assembly according to any one of Clauses 33-43, wherein the first conduit segment and the second conduit segment are configured to form a portion of a modular conduit system.

Clause 45: The conduit connector assembly of Clause 44, wherein the modular conduit system further comprises one or more corner conduit segments, each corner conduit segment configured to enable the modular conduit system to change direction.

Clause 46: The conduit connector assembly of Clause 45, wherein each corner conduit segment comprises a predetermined bend angle.

Clause 47: The conduit connector assembly of Clause 46, wherein the predetermined bend angle is selected from the group consisting of 22.5 degrees, 45 degrees, and 90 degrees.

Clause 48: The conduit connector assembly according to any one of Clauses 33-47, wherein the first cylindrical body and the second cylindrical body are configured to compress the one or more sealing elements when the male coupling portion is inserted into the female coupling portion.

Clause 49: A locking conduit connector comprising: a first coupling element configured to connect to a first conduit segment; a second coupling element configured to connect to a second conduit segment; and a locking mechanism configured to secure the first coupling element to the second coupling element and prevent accidental disconnection or rotation between the first conduit segment and the second conduit segment.

Clause 50: The locking conduit connector of Clause 49, wherein the locking mechanism comprises a snap lock.

Clause 51: The locking conduit connector of Clause 50, wherein the snap lock comprises a protrusion on one of the first coupling element or the second coupling element and a corresponding recess on the other of the first coupling element or the second coupling element, the protrusion configured to engage the recess when the first coupling element and the second coupling element are connected.

Clause 52: The locking conduit connector of Clause 49, wherein the locking mechanism comprises a threaded connection.

Clause 53: The locking conduit connector of Clause 52, wherein the first coupling element comprises a male threaded portion and the second coupling element comprises a corresponding female threaded portion, the male threaded portion configured to threadably engage the female threaded portion when the first coupling element and the second coupling element are connected.

Clause 54: The locking conduit connector of Clause 49, wherein the locking mechanism comprises a locking collar.

Clause 55: The locking conduit connector of Clause 54, wherein the locking collar is configured to slidably engage an outer surface of the first coupling element and an outer surface of the second coupling element when the first coupling element and the second coupling element are connected, thereby preventing disconnection.

Clause 56: The locking conduit connector of Clause 49, wherein the locking mechanism comprises a keyed connection.

Clause 57: The locking conduit connector of Clause 56, wherein the first coupling element comprises a first keyed portion and the second coupling element comprises a second keyed portion, the first keyed portion and the second keyed portion configured to interlock when the first coupling element and the second coupling element are connected in a specific orientation.

Clause 58: The locking conduit connector according to any one of Clauses 49-57, wherein the locking mechanism is configured to provide a predetermined level of strength, ease of use, or security.

Clause 59: The locking conduit connector according to any one of Clauses 49-58, wherein the first coupling element and the second coupling element comprise one or more materials selected from the group consisting of metal, plastic, and composite.

Clause 60: The locking conduit connector according to any one of Clauses 49-59, further comprising an adhesive disposed between the first coupling element and the first conduit segment, the adhesive configured to permanently secure the first coupling element to the first conduit segment.

Clause 61: The locking conduit connector of Clause 60, wherein the adhesive is selected from the group consisting of glue, cement, and epoxy.

Clause 62: The locking conduit connector according to any one of Clauses 49-61, further comprising a heat shrink material disposed over the first coupling element and the first conduit segment, the heat shrink material configured to permanently secure the first coupling element to the first conduit segment upon application of heat.

Clause 63: The locking conduit connector according to any one of Clauses 49-62, wherein the first conduit segment and the second conduit segment are configured to form a portion of a modular conduit system.

Clause 64: The locking conduit connector of Clause 63, wherein the modular conduit system is configured to be assembled in a first configuration and then unfolded or rearranged into a second configuration, the locking mechanism configured to maintain a secure connection between the first conduit segment and the second conduit segment in both the first configuration and the second configuration.

Clause 65: A pre-assembled cable and conduit system, comprising: a plurality of cable bundles, each cable bundle comprising a plurality of cables pre-cut to a predetermined length based on building plans and specifications; and a plurality of conduit assemblies, each conduit assembly comprising one or more conduit segments pre-cut to a predetermined length based on the building plans and specifications, wherein the plurality of cable bundles are pre-installed within the plurality of conduit assemblies to form a pre-assembled cable and conduit system.

Clause 66: The pre-assembled cable and conduit system of Clause 65, wherein at least one end of each cable within the plurality of cable bundles is pre-terminated with a connector.

Clause 67: The pre-assembled cable and conduit system of Clause 66, wherein the at least one pre-terminated end of each cable is configured for plug-and-play installation on-site.

Clause 68: The pre-assembled cable and conduit system according to any one of Clauses 65-67, wherein the plurality of cables comprises at least one of power cables, data cables, control cables, and telecommunications cables.

Clause 69: The pre-assembled cable and conduit system of Clause 68, wherein the telecommunications cables are pre-terminated and factory-tested to verify performance and provide test reports for each cable.

Clause 70: The pre-assembled cable and conduit system according to any one of Clauses 65-69, wherein each cable within the plurality of cable bundles comprises an identification tag at each end for easy final connections on-site.

Clause 71: The pre-assembled cable and conduit system according to any one of Clauses 65-70, wherein the pre-assembled cable and conduit system is manufactured in a controlled factory environment to ensure consistent quality and performance.

Clause 72: The pre-assembled cable and conduit system of Clause 71, wherein the controlled factory environment reduces waste of leftover cables and conduit materials compared to on-site assembly.

Clause 73: The pre-assembled cable and conduit system according to any one of Clauses 65-72, further comprising documentation of country of origin and manufacturing dates for all components, cables, and materials included in the pre-assembled cable and conduit system.

Clause 74: The pre-assembled cable and conduit system according to any one of Clauses 65-73, wherein the pre-assembled cable and conduit system is configured to reduce installation time, labor costs, and equipment costs compared to on-site assembly.

Clause 75: The pre-assembled cable and conduit system according to any one of Clauses 65-74, wherein the plurality of conduit assemblies comprises at least one of straight conduit segments, curved conduit segments, and junction boxes.

Clause 76: The pre-assembled cable and conduit system of Clause 75, wherein the curved conduit segments are configured to maintain a minimum bend radius of the plurality of cable bundles.

Clause 77: The pre-assembled cable and conduit system according to any one of Clauses 65-76, wherein the plurality of conduit assemblies comprises a plurality of modular conduit segments configured for snap-fit assembly.

Clause 78: The pre-assembled cable and conduit system according to any one of Clauses 65-77, wherein the plurality of conduit assemblies comprises at least one of metal conduit, plastic conduit, and flexible conduit.

Clause 79: The pre-assembled cable and conduit system according to any one of Clauses 65-78, wherein the pre-assembled cable and conduit system is configured for installation in at least one of a residential building, a commercial building, and an industrial facility.

Clause 80: The pre-assembled cable and conduit system according to any one of Clauses 65-79, wherein the pre-assembled cable and conduit system is configured to be shipped as a kit for on-site installation.

Clause 81: A pre-assembled cable and conduit system, comprising: a plurality of cable bundles, each cable bundle comprising a plurality of cables pre-cut to a predetermined length based on building plans and specifications; and a plurality of conduit assemblies, each conduit assembly comprising one or more conduit segments pre-cut to a predetermined length based on the building plans and specifications; wherein the plurality of cable bundles are pre-installed within the plurality of conduit assemblies to form a pre-assembled cable and conduit system.

Clause 82: The pre-assembled cable and conduit system of Clause 81, wherein at least one end of each cable within the plurality of cable bundles is pre-terminated with a connector.

Clause 83: The pre-assembled cable and conduit system of Clause 82, wherein the at least one pre-terminated end of each cable is configured for plug-and-play installation on-site.

Clause 84: The pre-assembled cable and conduit system according to any one of Clauses 81-83, wherein the plurality of cables comprises at least one of power cables, data cables, control cables, and telecommunications cables.

Clause 85: The pre-assembled cable and conduit system of Clause 84, wherein the telecommunications cables are pre-terminated and factory-tested to verify performance and provide test reports for each cable.

Clause 86: The pre-assembled cable and conduit system according to any one of Clauses 81-85, wherein each cable within the plurality of cable bundles comprises an identification tag at each end for easy final connections on-site.

Clause 87: The pre-assembled cable and conduit system according to any one of Clauses 81-86, wherein the pre-assembled cable and conduit system is manufactured in a controlled factory environment to ensure consistent quality and performance.

Clause 88: The pre-assembled cable and conduit system of Clause 87, wherein the controlled factory environment reduces waste of leftover cables and conduit materials compared to on-site assembly.

Clause 89: The pre-assembled cable and conduit system according to any one of Clauses 81-88, further comprising documentation of country of origin and manufacturing dates for all components, cables, and materials included in the pre-assembled cable and conduit system.

Clause 90: The pre-assembled cable and conduit system according to any one of Clauses 81-89, wherein the pre-assembled cable and conduit system is configured to reduce installation time, labor costs, and equipment costs compared to on-site assembly.

Clause 91: The pre-assembled cable and conduit system according to any one of Clauses 81-90, wherein the plurality of conduit assemblies comprises at least one of straight conduit segments, curved conduit segments, and junction boxes.

Clause 92: The pre-assembled cable and conduit system of Clause 91, wherein the curved conduit segments are configured to maintain a minimum bend radius of the plurality of cable bundles.

Clause 93: The pre-assembled cable and conduit system according to any one of Clauses 81-92, wherein the plurality of conduit assemblies comprises a plurality of modular conduit segments configured for snap-fit assembly.

Clause 94: The pre-assembled cable and conduit system according to any one of Clauses 81-93, wherein the plurality of conduit assemblies comprises at least one of metal conduit, plastic conduit, and flexible conduit.

Clause 95: The pre-assembled cable and conduit system according to any one of Clauses 81-94, wherein the pre-assembled cable and conduit system is configured for installation in at least one of a residential building, a commercial building, and an industrial facility.

Clause 96: A cable bundle pulling system for installing a cable bundle onto a data cable tray system, the cable bundle pulling system comprising: a series of pulleys configured to attach to the data cable tray system at strategic locations; and a cable bundle pull force detection device configured to monitor a pulling force applied to the cable bundle during installation; wherein the series of pulleys is configured to guide and support the cable bundle during installation onto the data cable tray system, and the cable bundle pull force detection device is configured to ensure that the pulling force does not exceed a maximum allowable pulling force for the cable bundle.

Clause 97: The cable bundle pulling system of Clause 96, wherein the strategic locations for attaching the series of pulleys include at least one of corners and long straight runs of the data cable tray system.

Clause 98: The cable bundle pulling system according to any one of Clauses 96-97, wherein the series of pulleys is configured to minimize friction and snagging of cables within the cable bundle during installation.

Clause 99: The cable bundle pulling system of Clause 98, wherein minimizing friction and snagging of cables reduces a risk of damage to the cables during installation.

Clause 100: The cable bundle pulling system according to any one of Clauses 96-99, wherein the series of pulleys is configured to make the installation process faster and easier compared to installing the cable bundle without the series of pulleys.

Clause 101: The cable bundle pulling system according to any one of Clauses 96-100, wherein the series of pulleys comprises a plurality of pulley assemblies, each pulley assembly comprising at least one pulley.

Clause 102: The cable bundle pulling system of Clause 101, wherein each pulley assembly is configured to attach to the data cable tray system using at least one of a clamp, a bracket, and a fastener.

Clause 103: The cable bundle pulling system according to any one of Clauses 96-102, wherein the cable bundle pull force detection device comprises at least one of a load cell, a strain gauge, and a force transducer.

Clause 104: The cable bundle pulling system according to any one of Clauses 96-103, wherein the cable bundle pull force detection device is configured to provide a visual or audible alert when the pulling force exceeds a predetermined threshold.

Clause 105: The cable bundle pulling system according to any one of Clauses 96-104, wherein the cable bundle pull force detection device is configured to automatically stop the installation process when the pulling force exceeds the maximum allowable pulling force.

Clause 106: The cable bundle pulling system according to any one of Clauses 96-105, wherein the cable bundle comprises at least one of power cables, data cables, control cables, and telecommunications cables.

Clause 107: The cable bundle pulling system of Clause 106, wherein the maximum allowable pulling force is determined based on a type and size of the cables within the cable bundle.

Clause 108: The cable bundle pulling system according to any one of Clauses 96-107, wherein the data cable tray system comprises a plurality of cable tray segments configured to support and route the cable bundle.

Clause 109: The cable bundle pulling system of Clause 108, wherein the data cable tray system further comprises a plurality of cable tray fittings configured to connect the plurality of cable tray segments.

Clause 110: The cable bundle pulling system according to any one of Clauses 96-109, further comprising a lubricant configured to be applied to the cable bundle during installation to reduce friction and pulling force.

Clause 111: The cable bundle pulling system according to any one of Clauses 96-110, wherein the series of pulleys is configured to be removable from the data cable tray system after installation of the cable bundle.

Clause 112: The cable bundle pulling system according to any one of Clauses 96-111, wherein the series of pulleys is configured to be reusable for installing multiple cable bundles.

Clause 113: The cable bundle pulling system according to any one of Clauses 96-112, further comprising a tensioning device configured to maintain a predetermined tension on the cable bundle during installation.

Clause 114: The cable bundle pulling system according to any one of Clauses 96-113, wherein the series of pulleys is configured to be adjustable to accommodate different sizes and configurations of the data cable tray system.

Clause 115: A conduit clamp cover for enclosing a cable bundle within a conduit assembly, the conduit clamp cover comprising: a first half and a second half configured to mate together and enclose a portion of the conduit assembly; a flexible, durable material forming the first half and the second half; and a snap-fit mechanism configured to securely connect the first half and the second half around the conduit assembly.

Clause 116: The conduit clamp cover of Clause 115, wherein the flexible, durable material is selected from the group consisting of rubber, silicone, thermoplastic elastomer (TPE), and polyvinyl chloride (PVC).

Clause 117: The conduit clamp cover of Clause 115 or 116, wherein the flexible, durable material is configured to conform to the shape of the conduit assembly when the first half and the second half are mated together.

Clause 118: The conduit clamp cover according to any one of Clauses 115-117, wherein the snap-fit mechanism comprises a plurality of interlocking tabs and slots disposed along edges of the first half and the second half.

Clause 119: The conduit clamp cover according to any one of Clauses 115-118, wherein the snap-fit mechanism is configured to provide a secure, removable connection between the first half and the second half.

Clause 120: The conduit clamp cover according to any one of Clauses 115-119, wherein the conduit clamp cover is configured to protect the cable bundle from dust, debris, and unauthorized access.

Clause 121: The conduit clamp cover according to any one of Clauses 115-120, wherein the conduit clamp cover is configured to provide a clean, finished appearance to the conduit assembly.

Clause 122: The conduit clamp cover according to any one of Clauses 115-121, wherein the first half and the second half are configured to be installed on the conduit assembly without the use of tools.

Clause 123: The conduit clamp cover according to any one of Clauses 115-122, wherein the conduit clamp cover is configured to be installed on the conduit assembly after the cable bundle has been inserted into the conduit assembly.

Clause 124: The conduit clamp cover according to any one of Clauses 115-123, wherein the conduit clamp cover is configured to be removed from the conduit assembly to allow access to the cable bundle for maintenance or repairs.

Clause 125: The conduit clamp cover according to any one of Clauses 115-124, wherein the conduit clamp cover is configured to be installed on straight segments of the conduit assembly.

Clause 126: The conduit clamp cover according to any one of Clauses 115-125, wherein the conduit clamp cover is configured to accommodate different sizes of conduit assemblies.

Clause 127: The conduit clamp cover of Clause 126, wherein the first half and the second half are configured to be trimmed to fit different sizes of conduit assemblies.

Clause 128: The conduit clamp cover according to any one of Clauses 115-127, wherein the conduit clamp cover is configured to be installed on a plurality of adjacent conduit assemblies to provide a continuous enclosure for the cable bundle.

Clause 129: The conduit clamp cover according to any one of Clauses 115-128, wherein the conduit clamp cover is colored to match the conduit assembly or to provide a visual indication of the type of cable bundle enclosed within the conduit assembly.

Clause 130: The conduit clamp cover according to any one of Clauses 115-129, wherein the conduit clamp cover is marked with indicia indicating the type of cable bundle enclosed within the conduit assembly.

Clause 131: A method for automating installation planning of a cable management system, the method comprising: receiving, by a computing device, building plans and specifications for a building; analyzing, by the computing device, the building plans and specifications to identify a plurality of cable runs and a plurality of conduit runs; grouping, by the computing device, the plurality of cable runs into one or more cable bundles based on a set of predetermined criteria; generating, by the computing device, a bill of materials (BOM) for the cable management system based on the one or more cable bundles and the plurality of conduit runs; generating, by the computing device, a set of installation instructions for the cable management system based on the one or more cable bundles and the plurality of conduit runs; and outputting, by the computing device, the BOM and the set of installation instructions.

Clause 132: The method of Clause 131, wherein analyzing the building plans and specifications comprises: identifying, by the computing device, a plurality of network devices and their locations within the building; identifying, by the computing device, a plurality of power sources and their locations within the building; and determining, by the computing device, the plurality of cable runs and the plurality of conduit runs based on the locations of the plurality of network devices and the plurality of power sources.

Clause 133: The method of Clause 131 or 132, wherein grouping the plurality of cable runs into one or more cable bundles comprises: applying, by the computing device, a set of predefined rules to the plurality of cable runs, wherein the set of predefined rules includes at least one of cable type, cable diameter, cable length, conduit fill ratio, and destination.

Clause 134: The method according to any one of Clauses 131-133, further comprising: optimizing, by the computing device, the one or more cable bundles and the plurality of conduit runs to minimize material usage and installation time.

Clause 135: The method according to any one of Clauses 131-134, further comprising: verifying, by the computing device, that the one or more cable bundles and the plurality of conduit runs comply with a set of predetermined standards and regulations.

Clause 136: The method according to any one of Clauses 131-135, wherein generating the BOM comprises: determining, by the computing device, a quantity and type of cable, conduit, and accessories required for each of the one or more cable bundles and the plurality of conduit runs; and aggregating, by the computing device, the quantities and types of cable, conduit, and accessories to generate the BOM.

Clause 137: The method according to any one of Clauses 131-136, wherein generating the set of installation instructions comprises: determining, by the computing device, a sequence of installation steps for each of the one or more cable bundles and the plurality of conduit runs; and generating, by the computing device, a graphical representation of the sequence of installation steps.

Clause 138: The method according to any one of Clauses 131-137, further comprising: generating, by the computing device, a set of labels for the one or more cable bundles and the plurality of conduit runs, wherein the set of labels includes at least one of a unique identifier, a source, and a destination for each cable bundle and conduit run.

Clause 139: The method according to any one of Clauses 131-138, further comprising: generating, by the computing device, a set of shop drawings for the cable management system based on the building plans and specifications, the one or more cable bundles, and the plurality of conduit runs.

Clause 140: The method according to any one of Clauses 131-139, further comprising: generating, by the computing device, a submittal package for the cable management system, wherein the submittal package includes at least one of the BOM, the set of installation instructions, the set of shop drawings, and a set of manufacturer specifications.

Clause 141: The method according to any one of Clauses 131-140, further comprising: generating, by the computing device, a cost estimate for the cable management system based on the BOM and a database of current prices for cable, conduit, and accessories.

Clause 142: The method according to any one of Clauses 131-141, further comprising: generating, by the computing device, a schedule for the installation of the cable management system based on the set of installation instructions and a set of project parameters.

Clause 143: The method according to any one of Clauses 131-142, further comprising: monitoring, by the computing device, the progress of the installation of the cable management system; and updating, by the computing device, the schedule based on the progress of the installation.

Clause 144: The method according to any one of Clauses 131-143, further comprising: generating, by the computing device, a set of as-built drawings for the cable management system based on the building plans and specifications, the one or more cable bundles, the plurality of conduit runs, and a set of field modifications made during the installation.

Clause 145: The method according to any one of Clauses 131-144, further comprising: providing, by the computing device, remote access to the BOM, the set of installation instructions, the set of shop drawings, the submittal package, the cost estimate, the schedule, and the set of as-built drawings to a plurality of users involved in the installation of the cable management system.

Clause 146: A system for automating installation planning of a cable management system, the system comprising: a computing device comprising a processor and a memory storing instructions that, when executed by the processor, cause the computing device to perform the method of any one of Clauses 131-145.

Clause 147: A processing system, comprising: a memory comprising computer-executable instructions; and a processor configured to execute the computer-executable instructions and cause the processing system to perform a method in accordance with any one of Clauses 131-145.

Clause 148: A processing system, comprising means for performing a method in accordance with any one of Clauses 131-145.

Clause 149: A non-transitory computer-readable medium storing program code for causing a processing system to perform the steps of any one of Clauses 131-145.

Clause 150: A computer program product embodied on a computer-readable storage medium comprising code for performing a method in accordance with any one of Clauses 131-145.

Clause 151: A method for factory pre-assembly of a cable management system, the method comprising: pre-cutting a plurality of cables to predetermined lengths based on an installation plan; bundling the plurality of cables together to form one or more cable bundles. In some aspects, Clause 151 may include at least one of: terminating at least one end of each of the plurality of cables with a connector and/or establishing one or more conduit assemblies, each conduit assembly comprising a plurality of conduit segments. In some aspects, Clause 151 may include pulling the one or more cable bundles through the one or more conduit assemblies to generate a factory fabricated conduit run. In some aspects, Clause 151 may include pulling the one or more cable bundles through the one or more conduit assemblies a location other than a bundle fabrication location.

Clause 152: The method of Clause 151, wherein terminating at least one end of each of the plurality of cables with a connector comprises terminating both ends of each of the plurality of cables with connectors.

Clause 153: The method of Clause 151, wherein terminating at least one end of each of the plurality of cables with a connector comprises terminating only one end of each of the plurality of cables with a connector.

Clause 154: The method of Clause 151, wherein bundling the plurality of cables together comprises wrapping the plurality of cables with a protective material.

Clause 155: The method of Clause 154, wherein the protective material is selected from the group consisting of shrink wrap, spiral wrap, and tape.

Clause 156: The method according to any one of Clauses 151-155, further comprising storing the one or more cable bundles on a spool for transportation to an installation site.

Clause 157: The method according to any one of Clauses 151-156, wherein the plurality of cables comprises at least one of power cables, data cables, control cables, and telecommunications cables.

Clause 158: The method according to any one of Clauses 151-157, wherein the one or more conduit assemblies comprise at least one of rigid conduit, flexible conduit, and pre-fabricated conduit bends.

Clause 159: The method according to any one of Clauses 151-158, wherein pulling the one or more cable bundles through the one or more conduit assemblies comprises using a cable pulling system comprising at least one of a pulling rope, a pulley system, and a motorized winch.

Clause 160: The method according to any one of Clauses 151-159, further comprising labeling each of the one or more cable bundles and the factory fabricated conduit run with a unique identifier.

Clause 161: The method according to any one of Clauses 151-160, further comprising testing the factory fabricated conduit run to verify connectivity and performance of the plurality of cables.

Clause 162: The method of Clause 161, wherein testing the factory fabricated conduit run comprises performing at least one of a continuity test, a signal attenuation test, and a data transmission rate test.

Clause 163: The method according to any one of Clauses 151-162, further comprising packaging the factory fabricated conduit run for transportation to an installation site.

Clause 164: The method of Clause 163, wherein packaging the factory fabricated conduit run comprises coiling the factory fabricated conduit run onto a spool or into a coil.

Clause 165: The method according to any one of Clauses 151-164, further comprising generating a bill of materials (BOM) for the factory fabricated conduit run, the BOM including a list of the plurality of cables, the one or more conduit assemblies, and any accessories used in the factory pre-assembly process.

Clause 166: The method according to any one of Clauses 151-165, wherein the factory pre-assembly process is performed in a controlled environment with a temperature range of 60° F. to 80° F. and a relative humidity range of 30% to 50%.

Clause 167: A method for modular installation of a cable management system, the method comprising: delivering a plurality of pre-assembled cable bundles to an installation site, wherein the pre-assembled cable bundles are assembled according to a factory pre-assembly process; delivering a plurality of conduit components to the installation site; routing the plurality of pre-assembled cable bundles through the plurality of conduit components to form a cable management system; and connecting the plurality of pre-assembled cable bundles to a plurality of endpoints according to an installation plan.

Clause 168: The method of Clause 167, wherein the plurality of pre-assembled cable bundles comprise cable bundles with pre-terminated connectors on at least one end.

Clause 169: The method of Clause 167, wherein the plurality of pre-assembled cable bundles comprise cable bundles without conduit components.

Clause 170: The method of Clause 169, further comprising installing the plurality of pre-assembled cable bundles onto a cable tray system.

Clause 171: The method of Clause 170, wherein installing the plurality of pre-assembled cable bundles onto the cable tray system comprises unspooling the pre-assembled cable bundles and pulling the pre-assembled cable bundles along the cable tray system.

Clause 172: The method according to any one of Clauses 167-171, wherein the plurality of conduit components comprise at least one of rigid conduit, flexible conduit, and pre-fabricated conduit bends.

Clause 173: The method according to any one of Clauses 167-172, wherein routing the plurality of pre-assembled cable bundles through the plurality of conduit components comprises using a cable pulling system comprising at least one of a pulling rope, a pulley system, and a motorized winch.

Clause 174: The method according to any one of Clauses 167-173, further comprising securing the plurality of conduit components to a building structure using fasteners.

Clause 175: The method according to any one of Clauses 167-174, further comprising labeling the plurality of pre-assembled cable bundles and the plurality of conduit components with unique identifiers corresponding to the installation plan.

Clause 176: The method according to any one of Clauses 167-175, further comprising testing the cable management system to verify connectivity and performance of the plurality of pre-assembled cable bundles.

Clause 177: The method of Clause 176, wherein testing the cable management system comprises performing at least one of a continuity test, a signal attenuation test, and a data transmission rate test.

Clause 178: The method according to any one of Clauses 167-177, further comprising updating the installation plan based on as-built conditions of the cable management system.

Clause 179: The method according to any one of Clauses 167-178, further comprising generating a bill of materials (BOM) for the cable management system, the BOM including a list of the plurality of pre-assembled cable bundles, the plurality of conduit components, and any accessories used in the modular installation.

Clause 180: The method according to any one of Clauses 167-179, wherein the modular installation methodology reduces on-site assembly time and minimizes the need for skilled labor compared to traditional cable installation methods.

Clause 181: The method according to any one of Clauses 167-180, wherein the modular installation methodology reduces on-site equipment requirements compared to traditional cable installation methods.

Clause 182: The method according to any one of Clauses 167-181, wherein connecting the plurality of pre-assembled cable bundles to the plurality of endpoints comprises plugging pre-terminated connectors on the pre-assembled cable bundles into corresponding jacks or outlets.

Clause 183: A method for integrated quality control and testing of a cable management system during a factory manufacturing process, the method comprising: monitoring, using a software tool, a plurality of quality control checkpoints during the factory manufacturing process; performing, using a testing equipment, a plurality of tests on a plurality of cable assemblies at predetermined stages of the factory manufacturing process; analyzing, using the software tool, data collected from the plurality of quality control checkpoints and the plurality of tests; identifying, using the software tool, any quality control issues or test failures; and generating, using the software tool, a quality control report for each of the plurality of cable assemblies.

Clause 184: The method of Clause 183, wherein the factory manufacturing process comprises at least one of cutting cables to length, terminating cables with connectors, and bundling cables together.

Clause 185: The method of Clause 183 or 184, wherein the plurality of quality control checkpoints comprises at least one of verifying cable lengths, inspecting connector terminations, and checking cable bundle integrity.

Clause 186: The method according to any one of Clauses 183-185, wherein the plurality of tests comprises at least one of a continuity test, a signal attenuation test, and a data transmission rate test.

Clause 187: The method according to any one of Clauses 183-186, wherein performing the plurality of tests comprises using at least one of a cable certifier, a network analyzer, and an optical time-domain reflectometer (OTDR).

Clause 188: The method according to any one of Clauses 183-187, further comprising storing the data collected from the plurality of quality control checkpoints and the plurality of tests in a database.

Clause 189: The method of Clause 188, further comprising analyzing the stored data to identify trends and patterns in quality control issues and test failures.

Clause 190: The method according to any one of Clauses 183-189, further comprising generating a statistical process control (SPC) chart based on the data collected from the plurality of quality control checkpoints and the plurality of tests.

Clause 191: The method of Clause 190, further comprising using the SPC chart to monitor and control the factory manufacturing process.

Clause 192: The method according to any one of Clauses 183-191, further comprising updating the software tool with new quality control checkpoints and test procedures based on changes to the factory manufacturing process or cable assembly specifications.

Clause 193: The method according to any one of Clauses 183-192, wherein identifying any quality control issues or test failures comprises comparing the data collected from the plurality of quality control checkpoints and the plurality of tests to predetermined thresholds or acceptance criteria.

Clause 194: The method according to any one of Clauses 183-193, further comprising displaying the quality control report on a user interface of the software tool.

Clause 195: The method according to any one of Clauses 183-194, further comprising sending the quality control report to one or more stakeholders via email or a file sharing system.

Clause 196: The method according to any one of Clauses 183-195, wherein the integrated quality control and testing method enables real-time identification and correction of issues during the factory manufacturing process.

Clause 197: The method according to any one of Clauses 183-196, wherein the integrated quality control and testing method simplifies on-site final installation verification tests by ensuring that pre-terminated cables are pre-certified with test reports from the factory.

Clause 198: The method according to any one of Clauses 183-197, further comprising using the quality control reports and test data to optimize the factory manufacturing process and improve overall cable assembly quality.

Clause 199: A method of installing a modular conduit assembly, comprising: providing a modular conduit assembly in a shipping configuration, the modular conduit assembly including: a plurality of straight conduit segments, and a plurality of corner conduit segments; unfolding the modular conduit assembly from the shipping configuration to form an elongated conduit assembly; and installing the elongated conduit assembly at an installation site to form a continuous, enclosed pathway for routing one or more cables.

Clause 200: The method of Clause 199, wherein unfolding the modular conduit assembly comprises unfolding the modular conduit assembly in a constrained space, including a hallway.

Clause 201: The method according to any one of Clause 199 or Clause 200, wherein the modular conduit assembly further includes one or more joint connectors configured to connect the plurality of straight conduit segments and the plurality of corner conduit segments.

Clause 202: The method according to any one of Clauses 199-201, wherein the modular conduit assembly further includes one or more unfolding conduit connectors configured to facilitate unfolding of the shipping configuration into the elongated conduit assembly.

Clause 203: The method of Clause 202, wherein the one or more unfolding conduit connectors includes a 180-degree swivel connector.

Clause 204: The method of Clause 203, wherein unfolding the modular conduit assembly comprises articulating the 180-degree swivel connector to transition the modular conduit assembly from the shipping configuration to a linear configuration.

Clause 205: The method according to any one of Clause 203 or 204, wherein the one or more unfolding conduit connectors includes an open-ended connector configured to expose one or more cables between adjacent straight conduit segments.

Clause 206: The method of Clause 205, further comprising connecting the adjacent straight conduit segments via a sliding connection after unfolding the modular conduit assembly.

Clause 207: The method according to any one of Clause 205 or 206, further comprising connecting the adjacent straight conduit segments via a sleeve connector after unfolding the modular conduit assembly.

Clause 208: The method according to any one of 199-207, wherein installing the elongated conduit assembly comprises securing the elongated conduit assembly to a building structure.

Clause 209: The method according to any one of Clauses 199-207, wherein the elongated conduit assembly includes one or more pre-installed cables.

Clause 210: The method of Clause 209, wherein the one or more pre-installed cables are selected from the group consisting of: power cables, telecommunications cables, and low-voltage cables.

Clause 211: The method according to any one of Clauses 199-210, wherein the modular conduit assembly is comprised of a material selected from the group consisting of: flexible conduit, liquidtight conduit, ultratite conduit, steel flexible conduit, and electrical metallic tubing (EMT) conduit.

Clause 212: The method according to any one of Clauses 199-211, wherein unfolding the modular conduit assembly comprises articulating the corner conduit segments relative to the straight conduit segments.

Clause 213: The method according to any one of Clauses 199-212, wherein installing the elongated conduit assembly comprises connecting the elongated conduit assembly to one or more cable trays, raceways, or building infrastructure components.

Clause 214: The method according to any one of Clauses 199-213, wherein installing the elongated conduit assembly comprises connecting the elongated conduit assembly to one or more electrical components or equipment.

Clause 215: The method according to any one of Clauses 199-214, wherein the module conduit assembly includes one or more wires.

Clause 216: The method according to any one of Clauses 199-215, wherein the plurality of corner conduit segments include flexible conduit.

Clause 217: A system for automating installation planning of a cable management system, the system comprising: a computing device comprising a processor and a memory storing instructions that, when executed by the processor, cause the computing device to perform the method of any one of Clauses 151-216.

Clause 218: A processing system, comprising: a memory comprising computer-executable instructions; and a processor configured to execute the computer-executable instructions and cause the processing system to perform a method in accordance with any one of Clauses 151-216.

Clause 219: A processing system, comprising means for performing a method in accordance with any one of Clauses 151-216.

Clause 220: A non-transitory computer-readable medium storing program code for causing a processing system to perform the steps of any one of Clauses 151-216.

Clause 221: A computer program product embodied on a computer-readable storage medium comprising code for performing a method in accordance with any one of Clauses 151-216.

Clause 222: An access point comprising: a junction box including one or more pre-installed wire connector blocks, wherein preinstalled wires are attached to the one or more preinstalled wire connector blocks.

Clause 223: The access point of Clauses 222, further comprising one or more conduit segments attached to the junction box.

Clause 224: The access point of Clause 223, wherein at least one of the one or more conduit segments are attached to at least one of a switch, plug, or data cable outlet box.

Clause 224: The access point of Clause 224, wherein at least one of the switch, plug, or data cable is preinstalled and prewired to the outlet box.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some”refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of installing a modular conduit assembly, comprising:
providing a modular conduit assembly in a shipping configuration, the modular conduit assembly including:
a plurality of straight conduit segments, and
a plurality of corner conduit segments;
unfolding the modular conduit assembly from the shipping configuration to form an elongated conduit assembly; and
installing the elongated conduit assembly at an installation site to form a continuous, enclosed pathway for routing one or more cables.

2. The method of claim 1, wherein unfolding the modular conduit assembly comprises unfolding the modular conduit assembly in a constrained space, including a hallway.

3. The method of claim 1, wherein the modular conduit assembly further includes one or more joint connectors configured to connect the plurality of straight conduit segments and the plurality of corner conduit segments.

4. The method of claim 1, wherein the modular conduit assembly further includes one or more unfolding conduit connectors configured to facilitate unfolding of the shipping configuration into the elongated conduit assembly.

5. The method of claim 4, wherein the one or more unfolding conduit connectors includes a 180-degree swivel connector.

6. The method of claim 5, wherein unfolding the modular conduit assembly comprises articulating the 180-degree swivel connector to transition the modular conduit assembly from the shipping configuration to a linear configuration.

7. The method of claim 4, wherein the one or more unfolding conduit connectors includes an open-ended connector configured to expose one or more cables between adjacent straight conduit segments.

8. A conduit assembly, comprising:
a plurality of conduit segments; and
one or more swivel connectors, each swivel connector coupled between adjacent conduit segments and configured to allow relative rotation between the adjacent conduit segments,
wherein the plurality of conduit segments and the one or more swivel connectors are configured to form a continuous conduit path.

9. The conduit assembly of claim 8, wherein at least one of the one or more swivel connectors is configured to provide a 180-degree range of rotation between the adjacent conduit segments.

10. The conduit assembly of claim 8, wherein each of the one or more swivel connectors comprises a central cylindrical connector.

11. The conduit assembly of claim 10, wherein the central cylindrical connector of at least one of the one or more swivel connectors includes one or more sealing elements.

12. The conduit assembly of claim 11, wherein the one or more sealing elements include an O-ring.

13. The conduit assembly of claim 10, wherein the central cylindrical connector of at least one of the one or more swivel connectors includes one or more bearings to facilitate rotation.

14. The conduit assembly of claim 8, wherein at least one of the one or more swivel connectors is configured to transition the conduit assembly from a shipping configuration to an extended configuration.

15. A conduit connector, comprising:
a connector body having a first end and a second end;
a first conduit interface disposed at the first end of the connector body and configured to engage a first conduit segment;
a second conduit interface disposed at the second end of the connector body and configured to engage a second conduit segment; and
one or more sealing elements disposed between the first conduit interface and the second conduit interface, the one or more sealing elements configured to provide a seal between the first conduit segment and the second conduit segment when the conduit connector is assembled.

16. The conduit connector of claim 15, wherein the one or more sealing elements include at least one O-ring.

17. The conduit connector of claim 16, wherein the at least one O-ring is seated in a groove formed in the connector body.

18. The conduit connector of claim 16, wherein the at least one O-ring is configured to be compressed between the first conduit segment and the second conduit segment when the conduit connector is assembled.

19. The conduit connector of claim 15, wherein the first conduit interface and the second conduit interface are slip-fit interfaces.

20. The conduit connector of claim 15, wherein the first conduit interface and the second conduit interface are configured to engage the first conduit segment and the second conduit segment, respectively, via a snap-fit connection.
